(19) United States
(12) Patent Application Publication
(10) Pub. No.: US 2025/0235788 A1
(43) Pub. Date: Jul. 24, 2025

(54) SYSTEMS AND METHODS FOR USER-GENERATED ENTERTAINMENT

(71) Applicant: Twenty Four 7, Inc., Portland, OR (US)

(72) Inventor: Michelle Lettunich, Portland, OR (US)

(21) Appl. No.: 19/034,476

(22) Filed: Jan. 22, 2025

Related U.S. Application Data
(60) Provisional application No. 63/624,704, filed on Jan. 24, 2024.

(51) Int. Cl. A63F 13/60; G06Q 50/00

(52) U.S. Cl. CPC A63F 13/60; G06Q 50/01

(57) ABSTRACT

Herein disclosed are systems and methods for a social platform. In one example, the method comprises receiving from a first database a real time event and players participating in the real time event; receiving a player selection from the players, and storing the player selection in a second database. The method includes receiving from the second database a plurality of collectable cards which comprise an effect that modifies a fantasy score of the real time event; defining a first set of the plurality of collectable cards to form a first deck of cards; accessing through a marketplace and storing a second set of the plurality of cards with the first set as an individualized deck of cards; receiving a card assignment to a player of the player selection; creating a score effect on the player; and determining the fantasy score integrating the real time event and the score effect.

### CROSS REFERENCE TO RELATED APPLICATIONS

The present application claims priority to U.S. Provisional Application No. 63/624,704 entitled SYSTEMS AND METHODS FOR USER-GENERATED ENTERTAINMENT filed Jan. 24, 2024. The entire content of the above application(s) are hereby incorporated by reference for all purposes.

### FIELD

The present application relates to systems and methods for generating personalized entertainment for users of a social platform based on user input.

### BACKGROUND AND SUMMARY

Conventional electronic gaming platforms, such as mobile apps and PC-game communities, suffer because they fail to provide users with variety and customization, and when such platforms provide variety and customization, they frequently target experienced gamers and fail to capture a more general audience. One reason for this challenge is that electronic gaming platforms do little to engage users to create personalized entertainment content, such as avatars, friend communities, original games, and marketplaces. Another factor limiting the success of electronic gaming platforms is that when they do encourage personalization, the platforms may lack simple processes and easy-to-follow user interfaces for generating personalized entertainment content, again, potentially losing the general audience.

One approach to increase use of gaming platforms is to provide opportunities for repeated play and continuous engagement with the gaming platform. For example, games that captivate players over an extended period of time, offer a variety of outcomes based on player choices, that track player interaction, and reward ongoing participation may increase engagement with the gaming platform. However, with many gaming platforms competing for attention of potential users, gaming platforms that lack original content, customization options, and have difficult user interfaces may miss opportunities to build a loyal player base.

Having identified the aforementioned challenges, the inventors herein have developed systems and methods that may enable personalized entertainment generation for users of a social platform based on user input. In one example, a method for a social platform, comprising: receiving from a first database a real time event and a plurality of players participating in the real time event; receiving a player selection from the plurality of players and storing the player selection in a second database, the player selection comprising a subset of players that is fewer in number than the number of players in the plurality of players; receiving from the second database a plurality of cards, the plurality of cards configured for collection by one or more users, and comprising an effect that modifies a fantasy score of the real time event; defining a first set of the plurality of cards to form a first deck of cards; accessing through a marketplace a second set of the plurality of cards and storing the second set and the first set of the plurality of cards as an individualized deck of cards in the second database; receiving a card selection from the individualized deck of cards, the card selection assigned to a player of the player selection; creating a score effect on the player; and determining the fantasy score integrating the real time event and the score effect.

The systems and methods lower the barrier to entry in platform experience customization and appeal to a variety of user interests, thereby encouraging participation across a wider range of potential users from experienced gamers to novices, and from casual sports fans to fantasy league enthusiasts.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE DRAWINGS

FIG. 1A shows an example of a social platform.

FIG. 1B shows an example of a computing system implementing the social platform.

FIG. 2A shows a first example of a card game system on the social platform.

FIG. 2B shows a second example of a card game system on the social platform.

FIG. 3 shows a high-level flowchart of a method for creating a card game group on the social platform.

FIG. 4 shows a high-level flowchart of a method for operating a card marketplace on the social platform.

FIG. 5 shows a high-level flowchart of a method for scoring a card game event on the social platform.

FIG. 6A shows examples of graphical user interfaces for creating a card game group on the social platform.

FIG. 6B shows further examples of graphical user interfaces for creating a card game group on the social platform.

FIG. 6C shows further examples of graphical user interfaces for creating a card game group on the social platform.

FIG. 7 shows examples of graphical user interfaces for gameplay during a card game event on the social platform.

FIG. 8 shows examples of graphical user interfaces for a card marketplace for a card game system on the social platform.

FIG. 9 shows a high-level flowchart of a method for card customization on the social platform.

### DETAILED DESCRIPTION

The following description relates to systems and methods for a social platform providing personalized entertainment and rewards to users based on user input. The social platform may comprise a website or other digital environment where users may display and interact with personalized entertainment and possibly earn rewards. Personalized entertainment may comprise user interests, such as games, challenges, competitions, contests, trophies, and social platform-based communities, including, for example, customizable and user-generated fantasy leagues, original games, digital art, and avatars. In one example, personalized entertainment may comprise a card game based on a customizable deck of cards that platform users may apply to any real time event that has a numeric scoring system. The card game may further include platform users choosing a fantasy team or lineup based on the event, applying one or more cards to the fantasy team, and determining a fantasy score integrating a scored outcome of the real time event and effect of cards applied to the fantasy team. The card game may further include building personalized decks of cards that are acquired variously through the social platform.

In one example, a platform user may invite one or more other users to a card game to form a card game group or league. The league may include performance statistics including a rank based on, for example, fantasy team selection, the outcome of one or more real time events, and cards played during the one or more real time events. A card game group may be one example of a social platform-based community. Rewards may comprise currency and/or access keys that may be used in a marketplace; however, in some cases users may also earn rewards for items that are not for purchase, such as, for example, digital goods, hard goods, or services. In a few other examples, the marketplace may comprise custom avatar pieces, sponsor-related products, experiences, digital goods, and hard goods. Marketplace goods may be sourced by platform administrators, offered by participating merchants (e.g., businesses, sponsors), and/or offered by platform users, including, for example, customizable and user-generated products. Marketplace goods may be acquired at auction and/or available purchase using virtual (or digital) currency or real currency. Rewards may be user-tailored in personalized marketplaces based on social platform interaction and user interests. In some examples, rewards may be user-generated and defined. In some examples, rewards may be portable between digital environments, such as portable between third party platforms. For example, a user may play a brand-hosted card game, and be rewarded with a gift card that may be on their site or other 3rd party site.

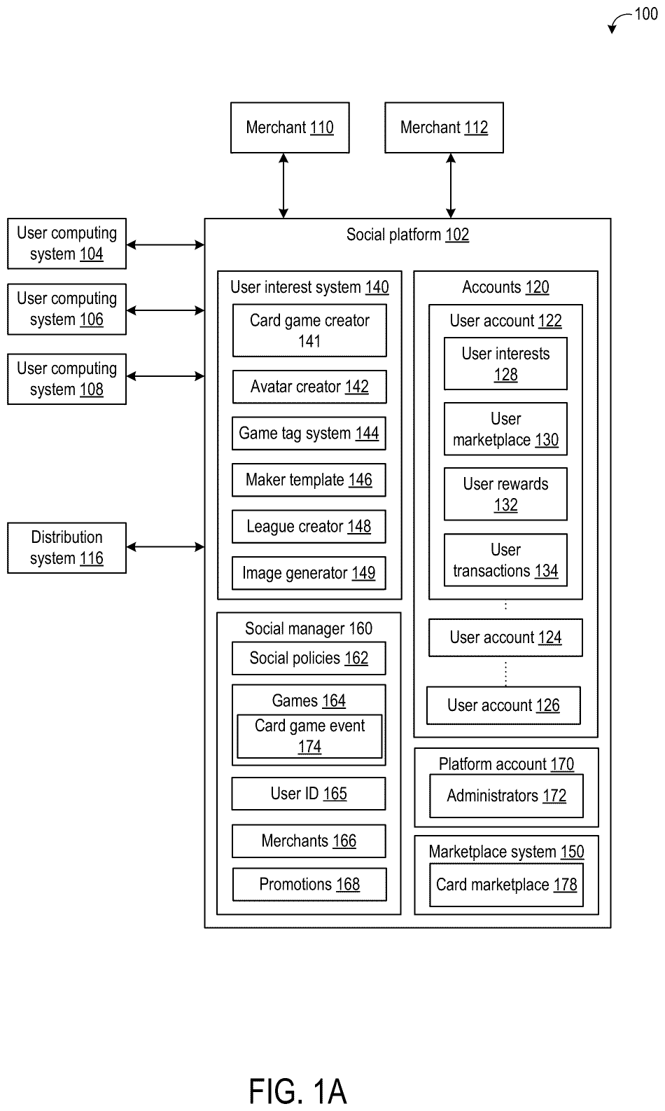

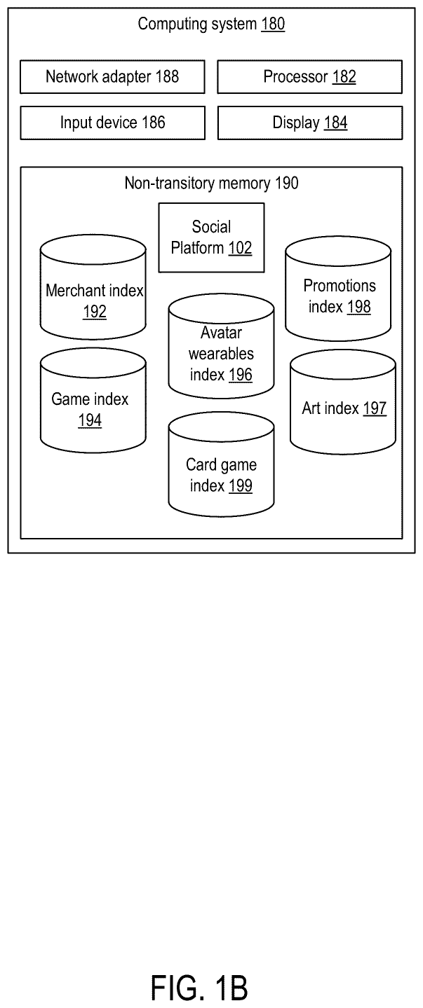

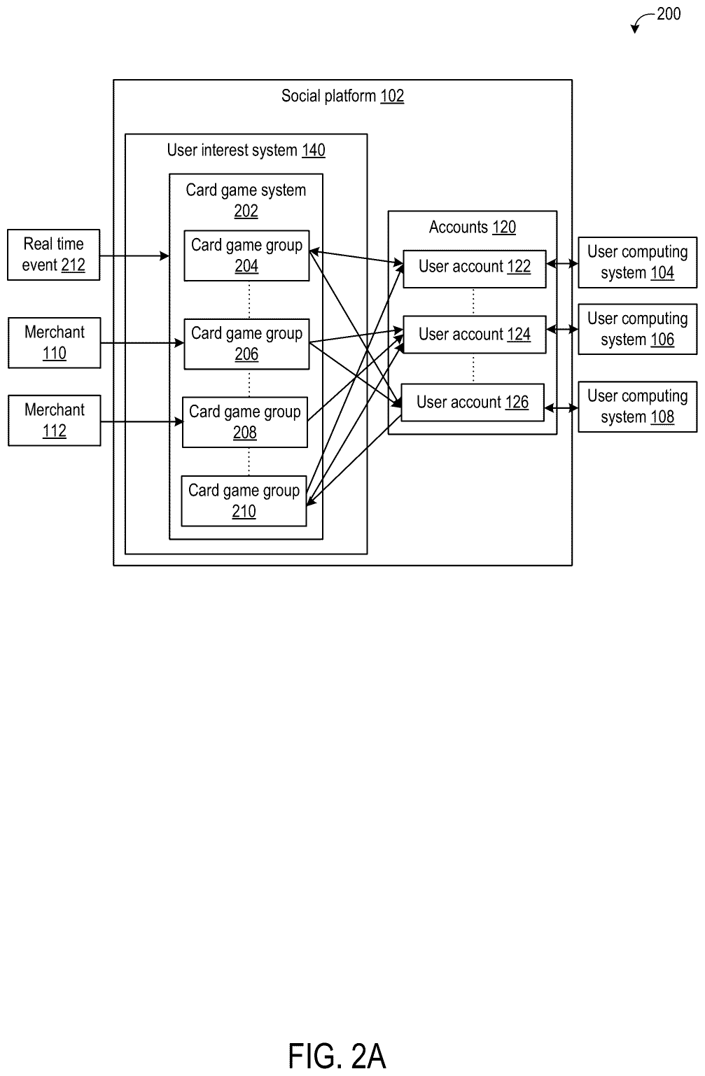

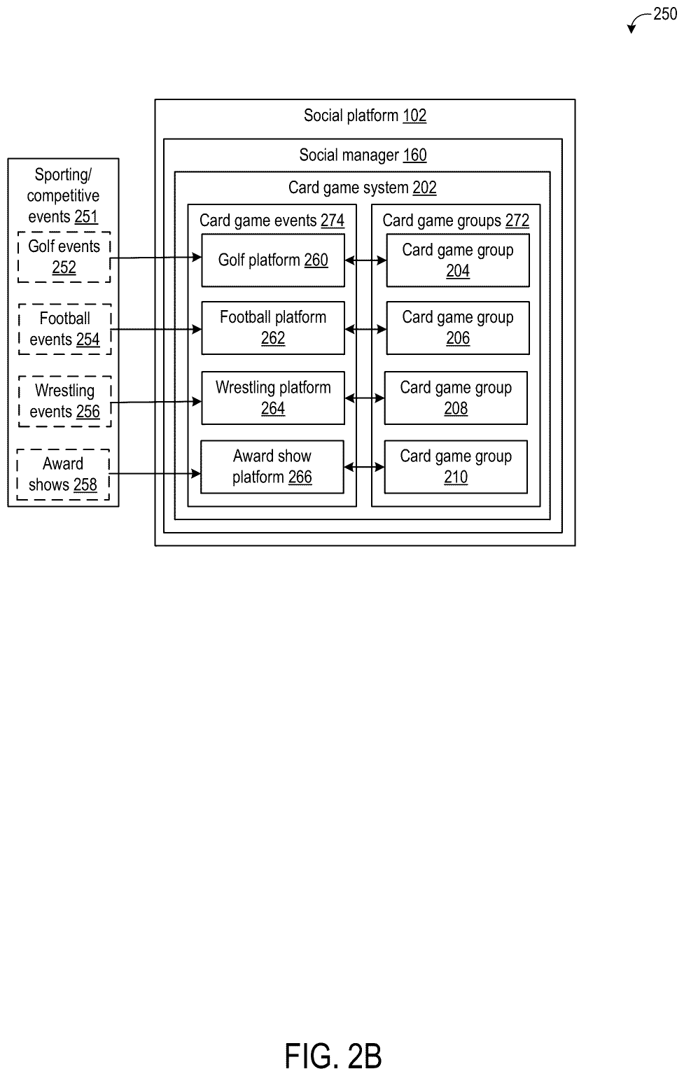

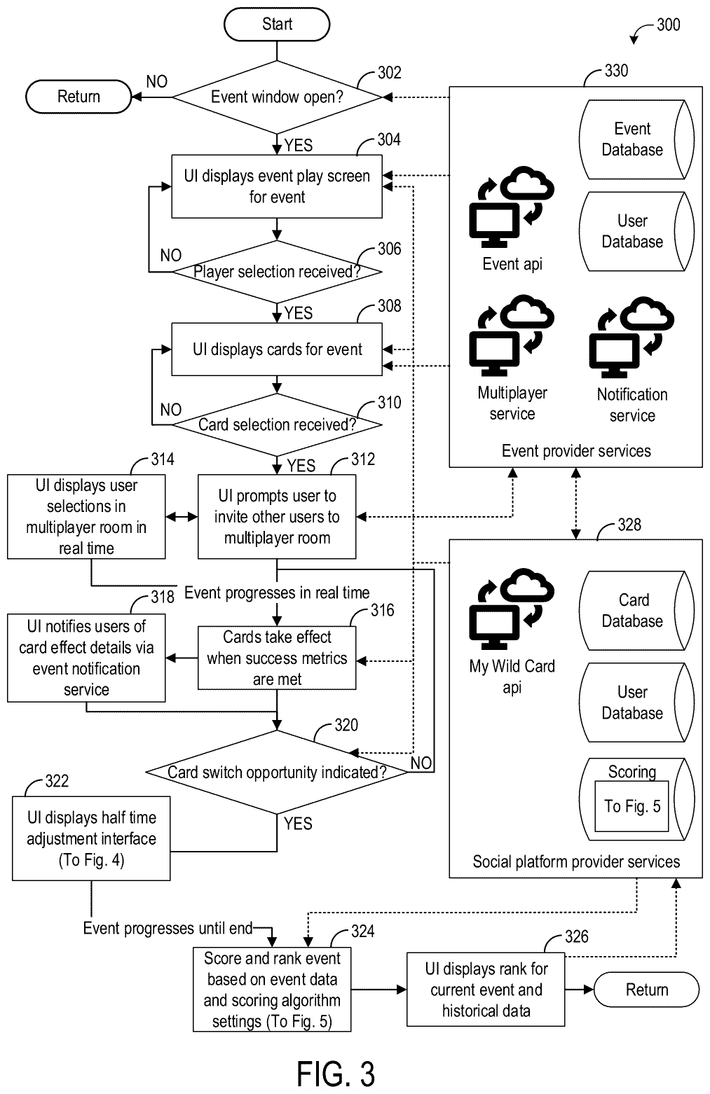

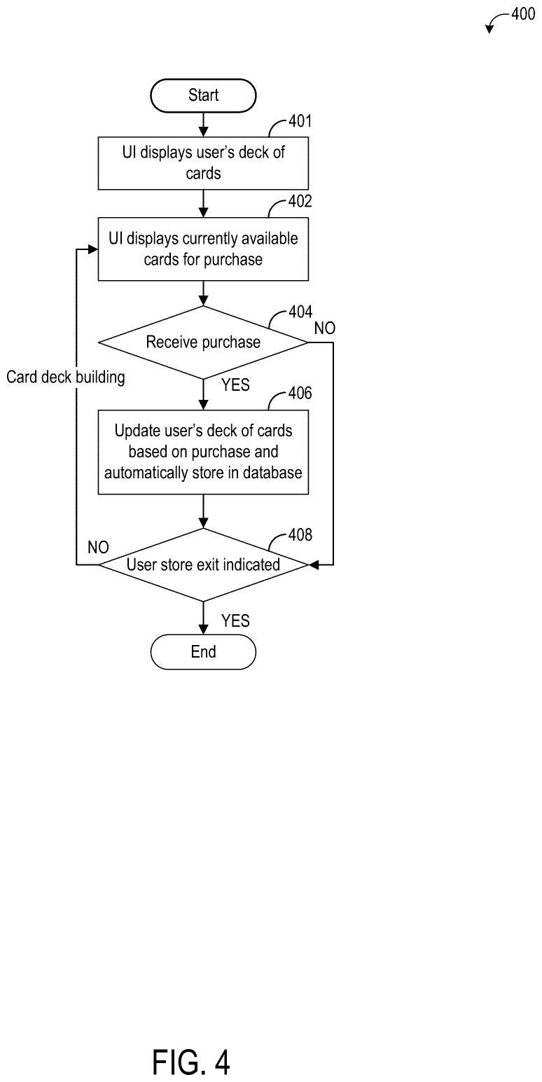

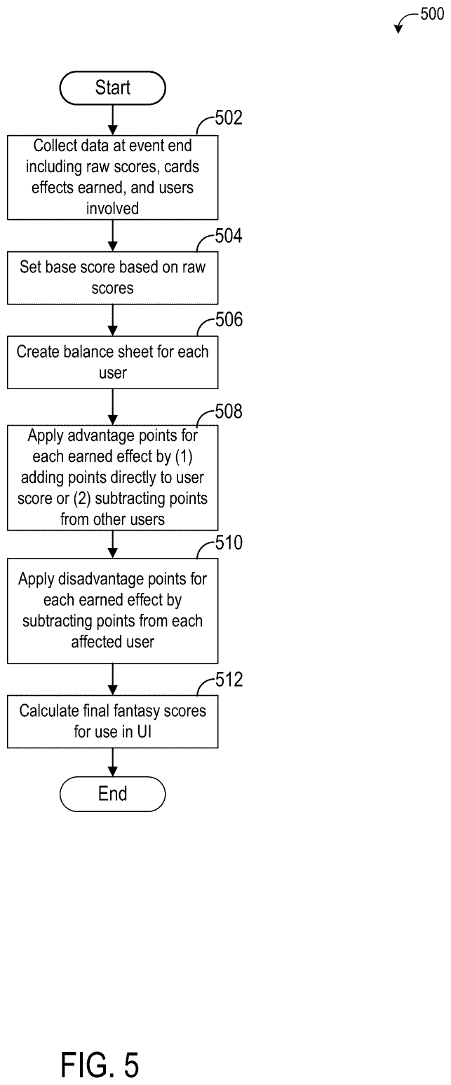

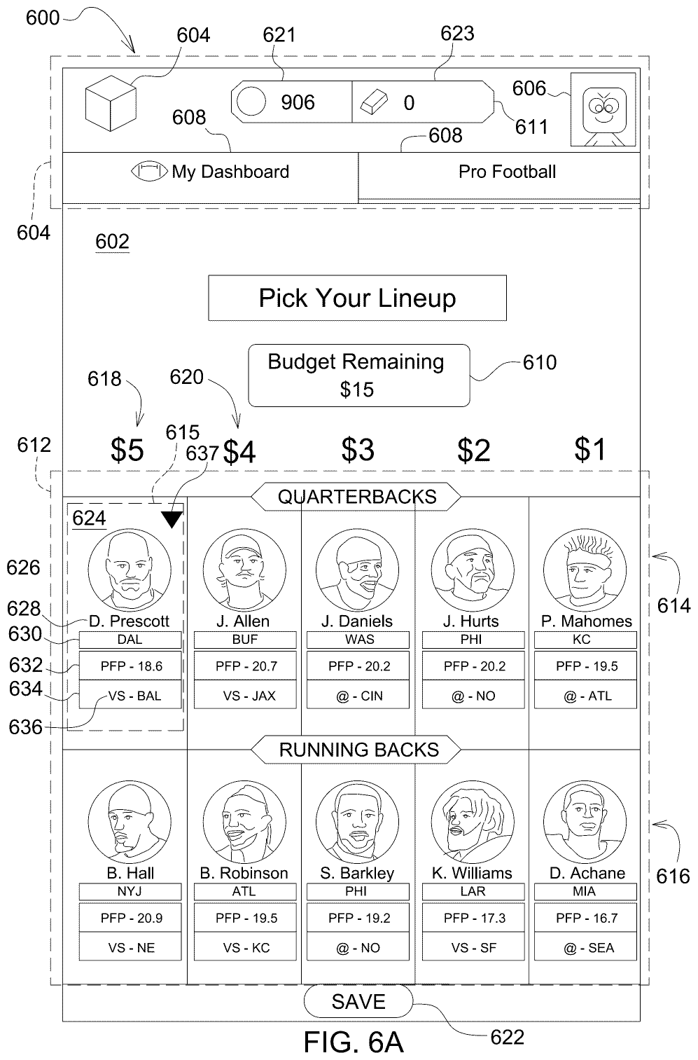

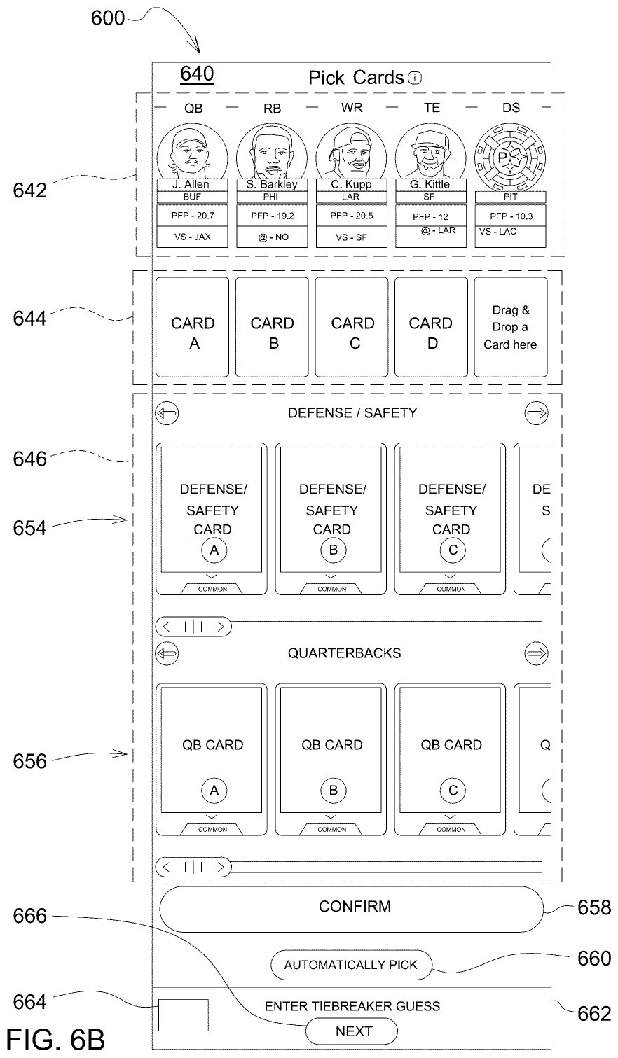

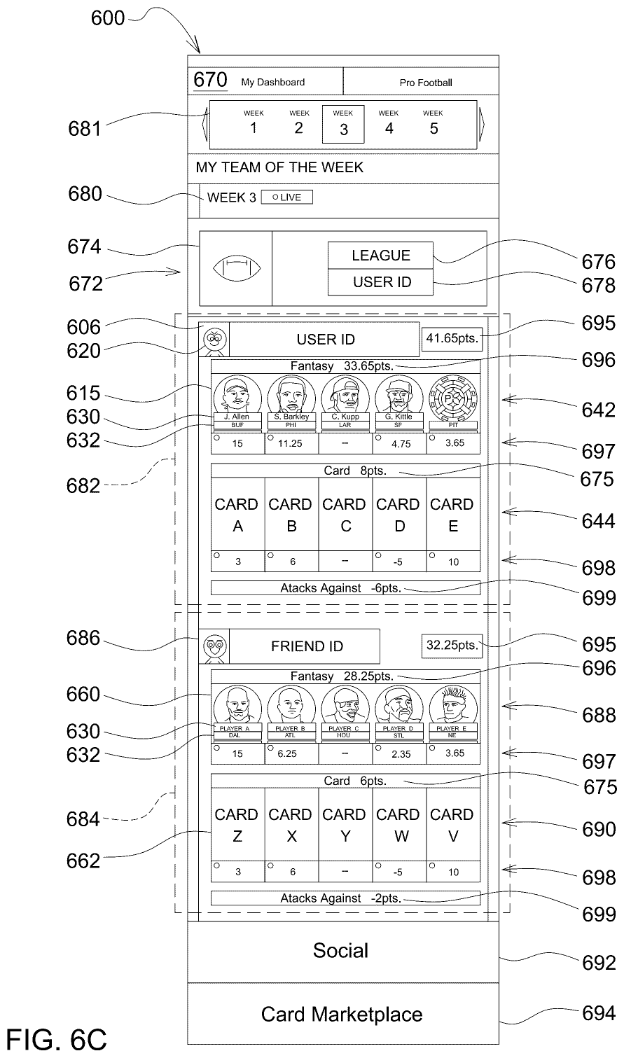

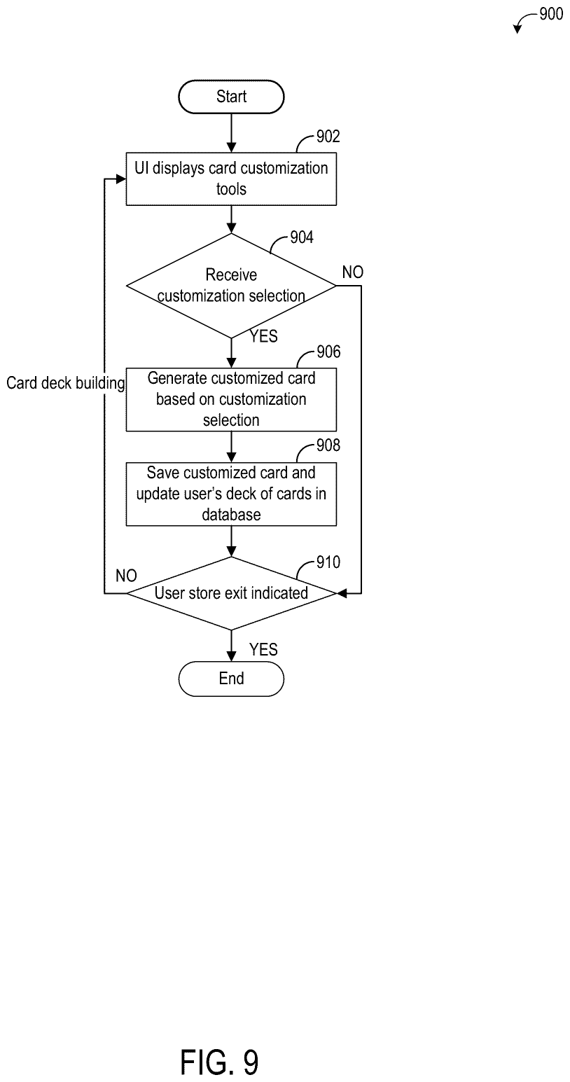

The following description provides examples of systems and methods that may enable a social platform, such as social platform 102 shown in FIG. 1A, to provide personalized entertainment, original content, and rewards to platform users while reducing a complexity of generating such content, and encouraging engagement with the social platform by a broad audience. The social platform may be implemented by one or more computing systems, such as computing system 180 shown in FIG. 1B. Computing system 180 may include a non-transitory machine-readable storage medium which may include instructions that when executed cause the computing system to perform operations, such as the method 300 discussed in detail below. It will be understood that social platforms, such as social platform 102, may be implemented by more than one computing system, such as in a distributed computing scheme, wherein various functionalities of the social platform may be enabled by a plurality of networked computing systems working in concert. Social platform 102 may comprise a marketplace system, such as marketplace system 150 shown in FIG. 1A, which may display products that are available for purchase or at auction using, for example, virtual currency, credit, or real currency. In some examples, the marketplace system may comprise a plurality of marketplaces, each marketplace based on an individual user's interaction with the social platform and displayed in a user marketplace tied to the user's account. Social platform 102 may comprise a user interest system, such as user interest system 140 shown in FIG. 1A and FIG. 2A, optionally comprising one or more tools for creating, displaying, and interacting with personalized entertainment that is accessible through the user's account. Social platform 102 may further comprise a social manager 160 shown in FIGS. 1A and 2B, optionally comprising one or more tools for managing social interactions between real time events, the social platform 102, and card game groups. As one example, the user interest system may include a card game system, including a tool for creating a card game group according to a method, such as the method 300 shown in FIG. 3. Example methods for operating a card marketplace are shown in method 400 of FIG. 4 and method 900 of FIG. 9. An example method for scoring a card game event is shown in method 500 in FIG. 5. FIGS. 6A-8 illustrate example graphical user interfaces that may be rendered by a display of a user computing system as part of a card game system on a social platform.

The disclosed methods and systems allow users to enhance sporting events and other real time events with a league creation and card deck-building layer and in doing so encourage social interaction and sustained play among users of a social platform. Platform users may build a virtual deck of cards by participating in platform-based challenges, competitions, contests, gifting, through purchase in the marketplace, and through game play, and in doing so, the user may collect an individualized (e.g., personalized, curated, user-selected) deck of cards. During a card game event, one or more cards may be played in an available slot that allows for modification of fantasy scores and specific data points based on real time event outcomes. Each card may have a card effect value that when played may have a positive or negative effect on event performance of a player or team, such as by increasing the score of the player who played the card or may decreasing the score of an opponent. Further, the cards and the outcome of the real time event may have combinatory effects. For example, cards may increase the fantasy score of the platform user depending on how well the fantasy team played in the real time event. In some examples, cards may be replaced or purchased during the card game event. Card game groups may include a leaderboard with statistics and metrics that track game play from variety of viewpoints giving users multiple ways earn a top spot in the league. In one example, at the end of a league season, a subset of cards may be stored by the user for use in a subsequent season. In one example, users may collect special cards that may be displayed on the social platform. In this way, by incorporating elements of skill in an accessible and social format, the disclosed systems and methods provide a customizable and competitive addition to fantasy league game play.

FIG. 1A schematically shows an example social platform system 100 including a social platform 102. Social platform 102 may be implemented by one or more computing systems. In one example, social platform 102 may be implemented by a server. In another example, social platform 102 may be implemented by a plurality of computing systems working in concert, such as through a network connection, wherein each of the plurality of computing systems may implement part of the social platform 102. Social platform 102 may be configured to electronically communicate with external computing systems, such as user computing systems 104, 106, and 108, merchants 110, 112, and distribution system 116. In one example, user computing systems 104, 106, 108 may be one or more mobile devices, tablets, and personal computers. In one example, social platform 102 may be configured to electronically communicate with one or more additional computing systems via a network such as the Internet, wherein the electronic communication may in one example comprise transmission and reception of data between the social platform 102 and one or more additional computing systems.

User computing systems 104, 106, 108, which may interface with social platform 102 via a network connection, may each be associated with at least one user and further associated with at least one user account stored in non-transitory memory of one or more a computing systems implementing social platform 102. As an example, use of the term “user” or “platform user” may refer to any individual or individuals who create an account on the social platform 102. Each user computing system may be associated with a user and thus enable the user to communicate with social platform 102. However, in some examples, a user may be able to access and interact with the platform without an account. In one example, the user computing systems 104, 106, 108 may be associated with user accounts 122, 124, 126 and may be any associated individual. User computer systems 104, 106, 108 may herein be referred to as users 104, 106, 108. Users associated with the user computing systems 104, 106, and 108 may register with the social platform 102 and display, create, and interact with user interests 128 generated on the social platform 102. Users associated with the user computing systems 104, 106, and 108 may view and make purchases at a user marketplace 130 generated on the social platform 102. Merchants 110, 112 may sell and promote goods to users associated with the user accounts 122, 124, 126 in a marketplace system 150 generated on the social platform 102.

User computing systems 104, 106, 108 may each include a processor, memory, communication interface, display, user input devices, GPS/position sensors, and/or other components. In one example, a location of user computing system 106 may be determined via a GPS system associated therewith. In one example, information from social platform 102 may be transmitted to user computing system 108 via a network connection (such as the Internet) between user computing system 108 and social platform 102, for rendering within an interface or display implemented at user computing system 106. The display may be used to present a visual representation of the social platform 102. This visual representation may take the form of a graphical user interface (GUI), examples of which are illustrated in FIGS. 6A-8. The communication interface may communicatively couple the social platform 102 with one or more other computing systems, such as the distribution system 116, user computing systems, and/or merchant computing systems. The communication interface may include wired and/or wireless communication devices compatible with one or more different communication protocols. As non-limiting examples, the communication interface may be configured for communication via a wireless telephone network, or a wired or wireless local- or wide-area network. User input device(s) may comprise one or more user-input devices such as a keyboard, mouse, touch screen, or game controller.

Merchants 110, 112 may be any merchant, business place, brand, entrepreneur, or entrepreneurial entity associated with social platform 102. In some examples, merchants 110, 112 may be users having a user account of accounts 120. As an example, use of the term “merchant”, “business”, or “brand” may contemplate any corporation, whether private or public. Each merchant may communicate with social platform 102, for example, via a merchant computing system. Each user computing system may include a processor, memory storing instructions executable by the processor, display, user input devices, and a communication interface.

Distribution system 116 may comprise one or more computing devices each including a processor, memory, communication interface, and/or other components. The memory of the computing device(s) of distribution system 116 includes instructions or rules for managing distribution of products sold by merchants in the marketplace system 150. For example, the distribution system 116 may include shipping and/or receiving via one or more logistics and shipping companies. In some examples, distribution system 116 may include discrete accounts (e.g., physical addresses), each of which may be associated with a user account 122, 124, 126 of accounts 120 on the social platform 102. In some examples, the distribution system 116 may include instructions or rules for managing distribution of digital or virtual goods purchased by users via the social platform 102.

Any of the computing devices, modules, or elements described herein with reference to FIG. 1A and FIG. 1B may communicate with each other via a network. For example, social platform 102 may communicate with the user computing systems 104, 106, 108, the merchants 110, 112, and the distribution system 116 via a network.

Social platform 102 may optionally include one or more or all of a plurality of modules including accounts 120, a user interest system 140, a social manager 160, the marketplace system 150, and platform account 170. As illustrated in exemplary FIG. 1B, the various modules of the social platform 102 may include instructions stored in non-transitory memory 190 that are executable by processor 182 of computing system 180. In other examples, the modules may be stored on multiple memories and/or executed by multiple processors distributed across multiple computing devices connected by a network.

Accounts 120 may be a module or database including instructions, information, and/or rules relating to personal and social platform information for each user 104, 106, 108 associated with the social platform 102. As an example, users 104, 106, 108 may register with social platform 102 via a smartphone, computer, or other network-enabled computing device in order to build and create user accounts 122, 124, 126 associated with (as an example) users 104, 106, 108, respectively, the accounts being stored in accounts 120. As an example, accounts 120 may include user information for each platform user, including, for example, one or more or all of user interests 128, user marketplace 130, user rewards 132, and user transactions 134.

User interests 128 may include personalized entertainment content that is displayed and accessed via a user's account, such as user account 122, on the social platform 102. For example, user interests 128 may include one or more of games, avatars, trophies, badges, last-played game, most-played games, game catalogs, social connections, affiliations, and brands. In one example, user interests 128 may include affiliation with or participation in one or more card game groups. Additionally, or alternatively, user interests 128 may include an option to display a deck of cards built by the user. In one example, badges may be earned through a badge system, and may comprise a graphic that a user earns through participating in challenges, competitions, contests, or other engagement with the social platform 102 that may be displayed on a user's account, such as user account 122. In one example, the badge system may be controlled by one or more platform administrators. In some cases, a badge may represent a trophy. In other examples, users may earn badges passively or receive badges as a gift. User interests 128 may be user-generated and/or user-customized, such as by one or more of user accounts 122, 124, 126, through modules of the user interest system 140 accessed via the social platform 102.

User marketplace 130 may include a personalized marketplace of goods that are available for purchase via the social platform 102. In some examples, user marketplace 130 may include certain marketplace items that are made available for purchase in response to the user unlocking access via completing a challenge, participating in a competition or contest, or through purchase. In a few examples, the user marketplace 130 may be stocked based on user interests 128, interaction with the social platform 102, and participating merchants, sponsors, and so on. For example, user marketplace 130 may include one or more of custom avatar pieces, sponsor-related products, experiences, digital elements for auction and/or purchase. User marketplace 130 may include digital and hard goods sourced by a platform account 170 having one or more administrators 172. In some examples, the user marketplaces may include digital or hard goods provided by brands affiliated with the platform.

User rewards 132 of a user's account may include the rewards for which the user is currently eligible based on user interaction with the social platform 102. In one example, user rewards 132 may be used to purchase items in the user marketplace 130. As another example, user rewards 132 may be used to enter competitions on the social platform 102. In one example, user rewards 132 may comprise a bank of virtual currency. For example, the rewards 132 may be presented on the social platform 102 as one or more of virtual gold bars, coins, cash, and so on. For example, user rewards 132 may include in-game or platform-based currency that can be earned or purchased with real currency. For example, there may be more than one form of in-game currency, such as a first in-game currency that may be purchased using real currency and a second in-game currency that may be earned or gifted through the platform. As used herein, real currency may refer to credit cards, debit cards, virtual wallets, or other devices capable of conducting electronic transactions, which are associated with a payment account, such as a checking account. In some examples, user rewards 132 may be awarded by playing in card game groups, activities, games, completing challenges, contests, and/or participating in competitions. In one example, user rewards may be awarded by completing in-platform tasks or challenges, which are tasks for users to fulfill with no competition from other users.

User transactions 134 may include a history of tracked user purchases executed by a user using user rewards 132 or real currency and tracked by the social platform 102 via platform account 170. User transactions 134 may communicate with distribution system 116 for receiving purchased goods.

User interest system 140 may include one or more modules for customizing the user interests 128 including, for example, generating personalized entertainment content such as avatars, games, trophies, social connections, user-generated art and goods. In one example, user interest system 140 may include one or more or all of card game creator 141, avatar creator 142, game tag system 144, maker template 146, league creator 148, and image generator 149. In one example, the card game creator 141 may enable users to create a platform-based social community including a card game group, card deck building, and fantasy league event game play. In one example, avatar creator 142 enables users to create a personalized online representation affiliated with social platform 102, which may be a user-generated character including clothes, hair, skin, accessories, avatar environment, etc. In another example, game tag system 144 is a simple categorization system that tags games to allow for precise game suggestion algorithms and content delivery. In some examples, the game tag system 144 may be controlled at a platform level by one or more administrators 172. In other examples, additionally, the game tag system 144 may be accessed by users to tag user-generated content. As a further example, maker template 146 is a simple, yet scalable, game metadata creation tool that simplifies game creation and sharing. In another example, league creator 148 enables users to create a fantasy football or other fantasy leagues quickly and without player knowledge. In another example, image generator 149 includes a generative artificial intelligence system using natural language to create cover art for user-generated games affiliated with social platform 102.

Increasing engagement with a social platform is not so simple. Whereas existing platforms struggle to connect with potential users by failing to appeal to general audiences, the modules disclosed herein provide a wide variety of approaches for customization and dynamic platform engagement through the user interest system 140, such as the example methods shown in FIGS. 3-5 for a card game system. Fantasy leagues are a growing interest. As a popular social activity, the card game creator 141 provides an easy way for users 104, 106, 108 to create and join fantasy leagues with a virtual card deck-building layer that modifies the basic fantasy league play and increases friendly competition through the social platform 102. After creating or joining a card game, users 104, 106, 108 may then select from a plurality of players (e.g., professional athletes) to create a lineup of players. Users 104, 106, 108 may then assign to each player a card, which modifies player and lineup scoring. Users 104, 106, 108 may start play with a minimum card allotment (e.g., ten cards, eighteen cards, etc.) and may earn, win, or buy more additional cards over time. Cards may have different effects based on one or more of player performance, weather conditions, live game attendance, team score, and so on. In some examples, the cards may include a visual indicator of the effect of the card on the fantasy score of a real time event.

Cards included in the card game system may provide an opportunity for the social platform 102 to collaborate with merchants, brands, and/or sponsors, e.g., merchants 110, 112. For example, users 104, 106, 108 may earn, purchase, and play cards that are created by brands affiliated with the social platform 102, e.g., a line of cards created by a sports beverage company. As another example, the social platform 102 may host challenges, contests, and competitions that allow users 104, 106, 108 to potentially earn cards or earn opportunities to purchase cards. As another example, one or more of platform administrators 172, users 104, 106, 108, and merchants 110, 112 may create cards in response to popular cultural and current events (e.g., card customization). As another example, users 104, 106, 108 may create custom platform content based on and inspired by card game groups and events. For example, users may create original spin-off games, trivia, custom avatar clothing and accessories based on card game groups and events. As another example, the card game creator 141 may allow users 104, 106, 108 to create a card game group for a group of users sharing a common interest, thereby increasing social connectivity among users of the social platform 102. For example, users 104, 106, 108 may create a card game group around an event, such as a reality TV competition or sports league, or among individuals with a common interest, such as work colleagues, classmates, teammates, and so on.

The card game creator 141 may provide an overlay for other experiences that may increase use of the card game system or the social platform 102. As one example, the card game creator 141 may include a notification system which may alert users 104, 106, 108 to upcoming opportunities for play, updated rankings, user and league statistics, invitations to join a league, opportunities to purchase cards, and so on. Further, the card game creator 141 may implement a sharing system, such as for sharing a league scoreboard with other users of the social platform 102. Custom merchandise and promotional items related to card game event outcomes may be customized based on the user interests 128 including associated sports, leagues, fan groups, brands, and other social content.

Card game, as used herein, is not limited to a card representation. Card game, as used herein, is representative of a game that is played virtually online in coordination with a real time event that may be scored numerically, including effects that players (e.g., users) may collect, customize, and apply according to game instructions to the real time event to affect the fantasy score of the real time event. For example, the card game may be represented by tokens, stickers, labels, images, spreadsheets, or other forms.

It should be appreciated, as used herein, that fantasy may include fantasy sports teams including user-selected lineups of real world athletes, and may also include non-sports related events, such as a reality game or show, a contest, an award show, etc., including user-selected lineups of participants or contestants. The fantasy score integrates real time event data and card effects. The real time event data may include the real life performance of the players or contestants in the user-selected lineup, and the scoring or fantasy points awarded to the player based on the performance may vary based on the real time event. For example, a fantasy football card game may implement a football-specific fantasy point scoring system, a basketball card game may implement a basketball-specific fantasy point scoring system, and a reality game show card game may implement yet another fantasy point scoring system.

Marketplace system 150 may include one or more modules and databases including instructions, information, and/or rules relating to goods displayed, generated, sold, and/or auctioned on the social platform 102. For example, the marketplace system 150 may include one or more modules for engaging with a plurality of marketplaces including personalized marketplaces curated for users, such as user marketplace 130, marketplaces curated by particular merchants, brands, and/or sponsors, as well as marketplaces created by users, such as user account 122. In one example, marketplace system 150 may include one or more processes through which brands affiliated with the social platform 102 may connect with users of the social platform 102. For example, a brand (e.g., one of merchants 110, 112) may create a virtual environment (e.g., a webpage) on the social platform 102 that the user accounts 122, 124, 124 may access to engage with the brand. The virtual environment may include one or more of brand-selected and/or brand-generated content, as well as user-generated content, including games, interests, promotional content, and goods for purchase with user rewards 132 or real currency. In another example, marketplace system 150 may include one or more processes through which user-created goods may be made available for purchase on the social platform 102. In some examples, rewards may be defined by a personalized entertainment creator such as one of users 104, 106, 108 and merchants 110, 112. In some examples, the social platform 102 may form relationships with one or more third parties, for example, a third parties that host or license personalized entertainment content generated on the social platform 102.

In one example, the marketplace system 150 may include a card marketplace 178. In one example, the card marketplace 178 may include cards for use in one or more card game groups that are available for purchase on the social platform 102. In one example, cards available in the card marketplace 178 may be created by one or more or all of platform administrators, platform-affiliated merchants, brands, sponsors, and platform users. As a few non-limiting examples, cards in the card marketplace 178 may include cards of varied game effect value and rarity, where the cost of the card in the card marketplace 178 increases with the rarity and strength of game effect value. For example, a card that adds more points to the score of the user when played may cost more than a card that adds fewer points. In one example, a card that adds more points to the score of the user when played, and may be rarer on the social platform 102, may be referred to as a premium or a legendary card, and a card with a lower effect value, which may be in greater circulation on the social platform 102, may be referred to as a common card. Legendary cards may add more even points to the fantasy score and may be even rarer than premium cards. In some examples, card cost may be related to rarity, with cards of limited availability costing more than cards that are more common. As another example, card cost may be related to a likelihood of the card going into effect, where the more likely the card is to going into effect, e.g., a lower threshold success metric, the more the card may cost. However, other factors may influence the cost of the card besides the examples provided herein.

In some examples, cards may be sold in multipacks. In some examples, additionally, or alternatively, cards sold in multipacks may include a random set of cards, such as three random cards, with a percentage chance of receiving a premium card or a legendary card (e.g., a one in twelve chance). In some examples, the card marketplace 178 may generate a personalized store that is displayed via the user accounts 122, 124, 126. For example, the personalized store may be generated for each card game playing user individually including a randomly generated set of cards available for purchase that are reset at a regular interval. For example, the regular interval may be daily or weekly. In one example, the personalized store for user account 122 may be displayed via user marketplace 130. In one example, the personalized store may include a timer that displays to the user the time when the set of cards available for purchase will be reset.

Optionally, social manager 160 may administer social policies 162 and update user interests 128 of accounts 120 with updated social policies relating to entertainment content from which a user may make a user interest selection. Social policies 162 may further include instructions or information relating to managing of the accounts 120 of the social platform 102. Social manager 160 may optionally include one or more or all of games 164, user identity 165, merchants 166, and promotions 168. Merchants 166 may be a database or module that may further represent suitable information regarding merchants, brands, businesses, sponsors, etc., affiliated with social platform 102, such as entertainment content and products offered, as well as tags to categorize merchants into interest groups. Optionally, such information may be stored in merchant index 192 shown in FIG. 1B. Games 164 may be a database or module which may further represent suitable information regarding games affiliated with social platform 102, and may include, for example, user-generated content, platform-generated content, and merchant-generated content, as well as tags to categorize user interests into interest groups, such as created and/or selected via the game tag system 144. In one example, games 164 may include one or more of a plurality of card game events 174. For example, card game events 174 may include a real time event, such as televised professional sports, game upon which a card game interface may be layered. In one example, social manager 160 may include tags or categories for games such as “multi-player” or “user-generated”. Users, merchants, and platform administrators may create and use the tags, which will enable game suggestion algorithms to grow audiences as they allow users to be made aware of games on the social platform 102. Optionally, such information may be stored in game index 194 shown in FIG. 1B. In one example, the game tag system 144 may enable users the ability to curate their own personalized content and may give the social platform 102 the ability to push games and other content to the users based on their selected tags. User identity 165 may comprise a database or module that may represent account customization content, such as, for example, avatars and avatar-wearables, as well as user ID tags to match account customization content with user accounts. Optionally, such information may be stored in an avatar wearables index 196, shown in FIG. 1B. In another example, user identity 165 may include one or more databases or modules which may represent user-generated art, user-generated digital environments. Optionally, such information stored in an art index 197 shown in FIG. 1B. In one example, user identity 165 may include a database of representing affiliations and/or social communities with which users engage, such as one or more card game groups. Optionally, such information stored in a card game index 199 shown in FIG. 1B. Social manager 160 may represent suitable information regarding promotions 168 of the social platform 102. For example, the social manager 160 may communicate with merchants, brands, businesses or other entities affiliated with the social platform 102 to promote entertainment content, user behavior, and goods. Such information may be stored in one or more of a promotions index 198 shown in FIG. 1B.

The social platform 102 may include platform account 170, which may comprise one or more administrators 172 enabled to make modifications to the social platform 102, for example, through the social manager 160 and the marketplace system 150, and modifying user access via accounts 120. Platform administrators 172 may further include administrators of a card game system, such as the card game system described below with reference to FIGS. 2A-2B.

Turning now to FIG. 1B, example computing system 180 is shown. Computing system 180 may implement social platform 102 alone, or in combination with other computing systems. In one example, computing system 180 may comprise a server. Computing system 180 includes display 184, input device 186, processor 182, network adapter 188, and non-transitory memory 190.

Display 184 may comprise a monitor, touch screen, projector, or any other device known in the art of computers for enabling a user to observe or sense information rendered by a digital device. Computing system 180 may have stored within non-transitory memory 190 instructions for rendering data, such as social platform 102 data, within a graphical user interface that may be displayed by display 184.

Input device 186 enables a user to interface/interact with computing system 180, and may comprise one or more hardware devices, such as a mouse, keyboard, touch screen, motion tracking camera, or other devices configured to transform user motions, gestures, sounds, or other user actions into an electronic form which may enable a user to input data, or transmit, select, modify, or otherwise interact with data or data structures stored in or displayed by computing system 180.

Processor 182 may include one or more physical devices configured to execute instructions stored in non-transitory memory. For example, processor 182 may be configured to execute instructions that are part of one or more applications, services, programs, routines, libraries, objects, components, data structures, or other logical constructs included in social platform 102.

Network adapter 188 comprises one or more physical device associated with computing system 180, enabling transmission, and reception of data between computing system 180 and one or more additional computing systems. Network adapter 188 may enable computing system 180 to access a local area network, and/or the Internet, and exchange data therewith, such as data that may enable tracking of user purchases and matching between transacting merchants registered with the social platform.

Non-transitory memory 190 includes one or more physical devices configured to hold data, including instructions executable by the processor to implement the methods and processes described herein. When such methods and processes are implemented, the state of non-transitory memory 190 may be transformed—e.g., to hold different data. The terms “module” and “program” may be used to describe an aspect of the computing system implemented to perform a particular function. The terms “module” and “program” may encompass individual or groups of executable files, data files, libraries, drivers, scripts, database records, etc. Non-transitory memory 190 includes the various files/routines/methods of social platform 102 that when executed by processor 182 perform one or more of the steps herein described with reference to one or more of the disclosed methods. Computing system 180 may optionally include display(s), user input device(s), communication interface(s), and/or other components.

Non-transitory memory 190 optionally includes one or more of merchant index 192, game index 194, avatar wearables index 196, art index 197, promotions index 198, and card game index 199. Merchant index 192 may be stored within non-transitory memory 190 of computing system 180, and may comprise a database or module containing information regarding merchants, businesses, sponsors, and brands registered with social platform 102. In one example, merchant index 192 may be used by computing system 180 in conjunction with accounts 120, user interest system 140, and marketplace system 150 to personalize user marketplaces such as user marketplace 130. For example, computing system 180 may be configured to implement one or more algorithms, such as an interest filtering tool, to estimate a likelihood that one or more users 104, 106, 108 may engage with one or more merchants 110, 112 stored in the merchant index 192. Similarly, game index 194 may be stored within non-transitory memory 190 of computing system 180, and may comprise a database or module containing information regarding games and game-related content on the social platform 102.

Avatar wearables index 196 may be stored within non-transitory memory 190 of computing system 180, and may comprise a database or module containing information regarding avatar wearables and other platform-identity customization tools, as well as user ID tags to match avatar customization content with user accounts on the social platform 102. Similarly, art index 197 may be stored within non-transitory memory 190 of computing system 180, and may comprise a database or module containing information regarding other platform customization tools, as well as user ID tags to match customization content with user accounts on the social platform 102. Card game index 199 may be stored within non-transitory memory 190 of computing system 180, and may comprise a database or module containing information regarding tools for generating card games, as well as user ID tags to match card game content with user accounts on the social platform 102. For example, card game content may include one or more or all of a database of cards on the social platform 102, cards in possession of platform users (e.g., individualized deck of cards or user card library), card game group affiliations, card game group player rosters, player statistics and metrics, league statistics and metrics, card game events, and card game scoring. Card game content and related data, such as, but not limited to, the aforementioned examples, may be stored in, updated, and retrieved from the card game index 199 for use according to the herein described systems and methods. One or more or all of game index 194, avatar wearables index 196, art index 197, and card game index 199 may be used by computing system 180 in conjunction with accounts 120, user interest system 140, and marketplace system 150 to personalize entertainment content. Further optionally, promotions index 198 may be stored within non-transitory memory 190 of computing system 180, and may comprise a database or module containing information regarding promotion and sponsor-related information on the social platform 102

FIG. 2A shows a schematic diagram 200 illustrating platform user and merchant interaction with the user interest system 140. The schematic diagram 200 represents one exemplary embodiment of a system for creating personalized entertainment content on a social platform, such as social platform 102. User interest system 140 includes a card game system 202 including processes for creating a plurality of card game groups by a plurality of users 104, 106, 108 and a plurality of merchants 110, 112. In one example, the card game system 202 may comprise a module supporting a virtual environment that is accessible via the social platform 102. In other examples, the card game system 202 may be accessible via a third party platform, such as a platform hosting or licensing the card game system 202. User interest system 140 further includes processes for inviting other platform users to join card game groups created by users 104, 106, 108 and merchants 110, 112. Elements of FIG. 2A that were previously illustrated and described above shall retain their numbering in FIG. 2A. While FIG. 2A represents an exemplary embodiment for creating and sharing card game groups on the social platform, it may be understood that a similar system may be applied to creating and sharing other categories of entertainment content on the social platform including, but not limited to, games, avatars, user-generated art, digital experiences, and so on.

The card game system 202 discussed with reference to FIG. 2A may comprise instructions stored in non-transitory memory of a computing system, such as a computing system 180 implementing social platform 102, wherein the instructions enable users 104, 106, 108 and merchants 110, 112 to create, suggest, promote, and play card game events within the card game system 202. Card game events are represented by real time event 212, which may be any numerically scored, or potentially numerically scored, sporting or competitive event that is viewable by users 104, 106, 108, e.g., televised, online, and so on. For example, merchant 110 may create a card game group 206, merchant 112 may create a card game group 208, user 104 may create a card game group 204, and user 108 may create a card game group 210 for the real time event 212. In one example, card game system 202 may include social communities of platform users, such as friends, colleagues, and users with common interests. For example, card game group 210 created by user 108 may include friends and relatives of user 108.

In one example, users 104, 106, 108 may display among personalized entertainment content one or more of the plurality of card game groups in which the user participates, such as via user interests 128 on user account 122. In some examples, users may participate in one or more of the card game groups to accumulate user rewards, which may be used in a personalized marketplace, such as user marketplace 130. For example, user interests 128 displayed on user account 122 may include card game group 204 and card game group 210. User interests displayed on user account 124 may include card game group 206, card game group 208, and card game group 210. User interests displayed on user account 126 may include card game group 210, card game group 204, and card game group 206. In some examples, one or more of merchants 110, 112 may display one or more of the plurality of card game groups on a brand-sponsored virtual environment on the social platform 102. For example, users 104, 106, 108 may view the card game group 206 via a brand-sponsored virtual environment created by merchant 110 and, in some examples, request to participate in the card game group 206.

FIG. 2B shows a schematic diagram 250 illustrating card game group and event platform interaction with the social manager 160. The schematic diagram 250 represents one exemplary embodiment of a system for managing personalized entertainment content on a social platform, such as social platform 102. Social manager 160 manages the card game system 202 including the interactions of a plurality of card game groups 272 with a plurality of sporting or other competitive events 251, which may be real time sporting or other competitive events. Social manager 160 may further include processes for notifying members of the plurality of card game groups 272 of relevant entertainment content including of the real time events upon which a card game interface may be layered, related promotions, merchandise, or other features of the social platform 102. Elements of FIG. 2B that were previously illustrated and described above shall retain their numbering in FIG. 2B. While FIG. 2B represents an exemplary embodiment for managing social content for a card game system on the social platform, it may be understood that a similar system may be applied to managing other categories of entertainment content on the social platform including, but not limited to, games, avatars, user-generated art, digital experiences, and so on.

The card game system 202 discussed with reference to FIG. 2B may comprise instructions stored in non-transitory memory of a computing system, such as a computing system 180 implementing social platform 102, wherein the instructions enable one or more card game groups to play a card game event for a real time event on a gaming platform of card game system 202. In a non-limiting example, sporting or competitive events 251 may optionally include any one or more or all of golf events 252, football events 254, wrestling events 256, and award shows 258. However, in other examples, sporting or other competitive events 251 may include fewer, more, or different events. Card game events 274 may include a plurality of platforms where members of one or more card game groups 272 may select a fantasy team for the real time sporting or other competitive event, apply cards to the selected fantasy team, view a near real time feed of cards as they go into effect throughout the event, and interact socially. For example, card game events 274 may include a golf platform 260 designed for golf events 252, a football platform 262 designed for football events 254, a wrestling platform 264 designed for wrestling events 256, and an award shows platform 266 designed for award shows 258.

The card game group 204 may access the golf platform 260 to play one or more card game events based on golf events 252. The card game group 206 may access the football platform 262 to play one or more card game events based on football events 254. The card game group 208 may access the wrestling platform 264 to play one or more card game events based on wrestling events 256. The card game group 210 access the award show platform 266 to play one or more card game events based on award shows 256. The card game groups 272 may play the card game during the real time event and otherwise interact socially via the platforms. After the real time event airs and the game play is scored for the card game groups 272, the card game system 202 may notify the card game groups 272 of future events that may interest their league. For example, the golf platform 260 may generate a notification alerting the card game group 204 of an upcoming golf tournament. As another example, the card game system 202 may notify card game groups 272 of card game content that may interest their league. For example, the wrestling platform 264 may generate a notification alerting the card game group 208 of a limited-edition card available for purchase in the card marketplace. As another example, the card game system 202 may notify card game groups 272 of social content that may interest their league. For example, the award show platform 266 may generate a notification alerting the card game group 210 of a celebrity fan club on the social platform 102.

Turning to FIGS. 3, 4, 5, and 9 example methods 300, 400, 500, and 900 for generating a card game group, building a deck of cards, and scoring a card game event are respectively shown. The method 300, and the other methods disclosed herein, may enable users to create personalized and immersive gaming experiences on a social platform in a simpler to use user interface (UI) than existing gaming platforms. In one example, the method 300, and the other methods disclosed herein, may be stored in non-transitory memory of a computing system implementing a social platform, such as computing system 180 and social platform 102 in FIG. 1B and FIG. 1A, respectively, and one or more, or all, of the steps of the method 300, and the other methods disclosed herein, may be automatically executed by the social platform, or by one or more subcomponents, modules, databases, or subsystems of the social platform. In one example, the method 300, and other methods disclosed herein, may be executed as part of a card game system in coordination with a real time event, for example, the card game system 202 in coordination with the real time event 212, including one or more of the card game creator 141, card game events 174, and card marketplace 178, as described with reference to FIGS. 1A-2B. In one example, the method 300 may allow the card game system to receive real time event data, such as fantasy points earned during the real time event, and determine a fantasy score integrating the real time event and effect of cards applied to the fantasy team. For example, fantasy points may be provided by an event application programing interface (API) and the modified score based on game play may be provided by a card API. In one example, the method may function as an overlay of additional features on top of existing web applications.

The card game system may communicate electronically, e.g., wirelessly via a cloud network, with one or both of event provider services 330 and social platform provider services 328 to carry out one or more aspects of the method 300, the method 400, the method 500, and the method 900. In one example, event provider services 330 may include an event database, a user database, an event API, a multiplayer service, and an event notification service. Additionally, or alternatively, event provider services 330 may comprise a first database storing a real time event and a plurality of players participating in the real time event. In one example, social platform provider services 328 may include a card database, a platform-user database, a scoring system and a card API. The social platform provider services 328 may comprise a second database storing a plurality of cards, decks of cards collected by users, selected lineups by one or more users of the social platform, and cards assigned to the lineups as part of one or more card game groups. Dotted lines indicate a transfer of data between one of the event provider services 330, the social platform provider services 328 and the card game generator system.

The method 300 initiates in response to the social platform determining that a user has accessed a startup screen associated with a user account. The startup screen may be displayed within a UI on the social platform which may be displayed by a display (e.g., a display 184 in FIG. 1A). As one example, the method may include the user clicking “play” on an event start menu of the UI. In one example, a button may represent “play”. As used herein, button may refer to any type of user input that provides a user a mechanism to select, confirm, or otherwise indicate a choice. An example “play” button of an exemplary graphical user interface is shown in FIG. 6A.

At 302, the method may include determining whether an event window is open. For example, a card game event may be playable within the event window on which a card game UI is layered. In one example, the event window may comprise non-zero, positive value threshold airtime for a real time event. As a few non-limiting examples, a real time event may include any viewable event that is played live with a numeric scoring system, such as professional sports game, an amateur sports game, or for which a numeric scoring system may be generated, such as an award ceremony or a reality television competition. For example, a first threshold airtime may include a range of time relative to a game start, such as six hours or fewer until the game start and less than half time into game play. In one example, the event window may be determined based on the card game system communicating with the event database accessed via the event provider services 330. In response to determining the event window is not open yet or has closed, the method may include returning to the start menu. In one example, the method may further include displaying a message to the user including the event window. In one example, the method may further include displaying a message to the user to indicate a desire to be notified when the event window is open. In one example, users may invite friends to an existing league outside of the event window. In some examples, users may not create a new league during a live sporting event or past a certain time into the live sporting event. However, in other examples, the method may include users creating a new league during the live sporting event (e.g., within a gameplay window). For example, the new league created during the live sporting event may be created for the next window of gameplay.

In response to the method determining the event window is open, at 304, the method may include displaying an event play screen for the event with the card game UI overlay. For example, the card game UI overlay may include a league creation interface with a plurality of players, a budget, and customization options. An exemplary card game UI overlay is shown in FIGS. 6A-6C. In one example, the plurality of players may comprise an automatically generated group of top ranked players. As one non-limiting example, the plurality of players may comprise a basketball player grid may include a top five players for each position on a basketball team, e.g., point guard, shooting guard, small forward, power forward, and center. In such an example, the player grid may include 25 players from which user may select a five-player team or lineup. In one example, player rank may be determined using fantasy points assigned by the event API. In one example, the players may be assigned a numeric value based on their place in the player rank for each position. For example, numeric values may be assigned to each player with the highest numeric value assigned to the top ranked player and the lowest numeric value assigned to the lowest ranked player. One example of numeric values may be a dollar value; however, other values are possible. The user may select a player for each position without exceeding their budget. In one example, the player grid is frozen once a new league is created by the user. In one example, the fantasy points assigned to each player on the player grid may be adjusted until the end of the league play window. In one example, the user who creates the new league is referred to as a league commissioner or a commissioner. In one example, the UI includes a logic that creates grids based on divisions within a professional league, such as the NCAA conference, the NFL conference, and so on.

In one example, the players who populate the player grid may be filtered by injury status. For example, players may be filtered from the player grid who are tagged as unlikely to play due to injury. In one example, such determinations may be made in communication with the event database via the event provider services 330. In another example, players may be filtered by team. As one example of filtering by team, the player grid may include no more than two players from a single team listed in a single position. However, other filters are possible. In one example, the league commissioner may customize and edit the player grid during league creation including, for example, choosing a custom player grid that replaces the rank logic. In another example, the league commissioner may run the player grid run in a mode wherein the player grid may change and update based on the rank logic until a first user makes a lineup selection, at which point the player grid may be frozen. In another example, users may edit their player lineup until a first scheduled game begins.

In one example, the commissioner may customize the league. For example, the league creation interface may include prompts for the commissioner to provide a league name and keywords for league cover art generation. In one example, a generative artificial intelligence system may generate a plurality of images from the keywords using natural language. The commissioner may select an image from the plurality of images, which may be stored in the user database and populated in the card API via the social platform provider services 328. In one example, the generative artificial intelligence system may be the same or similar to the image generator 149 of the user interest system 140 in FIG. 1A.

At 306, the method may include determining whether a player selection is received. In one example, the determination may be made based on the user selecting the player lineup and the user clicking “save team” in the card game UI. In one example, a button may represent “save team”. In response to determining the player selection is not received, the method may return to 304 where the league creation interface is displayed.

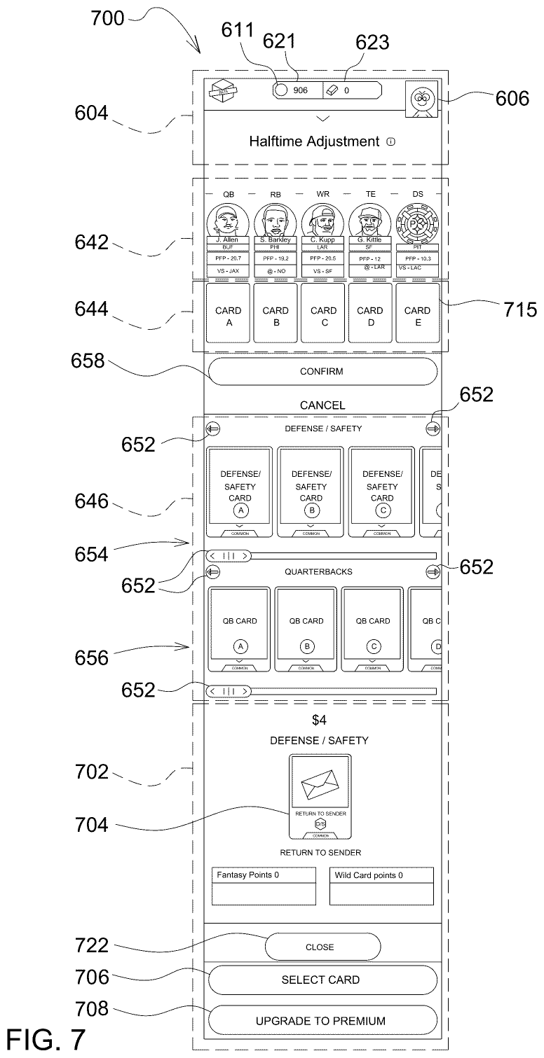

In response to the method determining the player selection is received, at 308, the method may include the card game UI overlay displaying a card selection interface. Example card selection interfaces are shown in FIGS. 6A-6C and FIG. 7. In one example, in each card game event, the user may select a non-zero positive value threshold number of cards. For example, a set or “deck” of cards may be displayed to the user, and the user may select a subset or “hand” of cards to play for the event. In one example, the effect of each card may include one of an advantage effect that increases the fantasy score of the real time event and a disadvantage effect that reduces the fantasy score of the real time event. Continuing with the basketball example above, the user may select up to one for each of the five positions on the basketball lineup. In one example, the user may select fewer cards than positions. In one example, card selection may not be tied to a card budget, a card value cap, or total amount of added value the cards can potentially add to the lineup. For example, a card may be assigned to each player on the lineup regardless of the potential value of the individual cards. Additionally, or alternatively, the user may select one or more attack cards, which negatively affect one or more opponents against whom the attack card is played (e.g., other users in the card game group). Cards may have different effects during game play based on player statistics and performance. In one example, cards displayed in the card selection interface may be generated based on the card game system in communication with the user database and the card database accessed via one or both of the event provider services 330 and the social platform provider services 328.

In one example, new users may create or join a league with a starter deck of cards. For example, new users may be provided a first deck of cards comprising an assigned subset of the plurality of cards. In some examples, the starter deck is a non-randomly assigned set of cards that is provided to all users at the onset of a new sport and/or season. For example, the platform administrator may determine which cards are included in the starter deck. In other words, each player may receive the same starter deck, which they may then upgrade variously, as described herein. Return users may possess more cards, or different cards, than the starter deck of cards. As one example, the user may visit a card marketplace and purchase new cards which may be added to the starter deck of cards to create an individualized deck of cards. Additionally, or alternatively, users may receive cards through gifting via the social platform, and may earn cards through challenges, competitions, and contests to create the individualized the deck of cards. However, in some examples, a player may select cards for the event from the starter deck, that is, from a deck of cards that has not been upgraded or otherwise modified. An example method for building an individualized deck of cards via a card marketplace is described with reference to FIG. 4. As an example, the user may visit one or both of the card marketplace 178 and a personalized store generated for the individual user (e.g., via user marketplace 130 on user account 122). The user may purchase from the card marketplace or personalized store one or more cards and select cards for game play from the updated set.

At 310, the method may include determining whether a card selection is received. In one example, the determination may be made based on the user clicking “lock in cards” in the card game UI. In one example, a button may represent “lock in cards”. In response to determining the card selection is not received, the method may return to 308 where the card selection interface is displayed.

In response to determining the card selection is received, at 312, the method may include the card game UI overlay automatically prompting the user to invite friends to a multiplayer room. For example, the commissioner or league creator may invite to the new league other users of the social platform 102 (e.g., a second user, a third user, etc.) and friends who are not affiliated with the social platform 102. An example interface where a user may invite friends to a league is shown in FIG. 6C. In one example, the multiplayer room may be generated with the card game UI overlay in coordination with the multiplayer service provided via the event provider services 330. For example, the multiplayer room may use an API, such as a self-hosted API or a multiplayer service API. One example multiplayer service may include Socket.io.

In one example, a button may represent “invite friends”. For example, the commissioner selecting “invite friends” may generate a first choice and a second choice from which the user may select: invite new friend and invite friend from database. In response to the user selecting to invite a new friend, the method may include generating a link to the league. The user may send the link via the device of the user, e.g., phone, tablet, etc., using a native application of the device. As another example, a list of platform friends of the user may be displayed and the user may send the link directly to the account of one or more selected platform friends. The commissioner may submit the invitation by clicking a “done” button, which notifies the friend of the invitation in coordination with one or both of the event provider services 330 and the social platform provider services 328. In response to commissioner selecting to invite a user from a database, the method may include presenting a drop down list of users to the commissioner. In one example, in response to the commissioner selecting to invite a user from a database, the method may include pinging the user database via the social platform provider services 328. The commissioner may submit the invitation by clicking a “done” button, which notifies the user of the invitation in coordination with one or both of the event provider services 330 and the social platform provider services 328.

In one example, card game groups or leagues may include a non-zero, positive value threshold league size. Continuing with the basketball example, up to four friends may accept the invitation from the commissioner for a threshold league size of five members. In other examples, the threshold league size may be higher or lower. In other examples, additionally, or alternatively, the threshold league size may be based on one or more or all of the sport type, event type, a participation level on the social platform, a rank on the social platform, a subscription tier (e.g., paid, free), a reward system, or other factors.

At 314, the method may include the card game UI overlay displaying user selections in the multiplayer room in real time. For example, one or more friends who accept the invitation of the commissioner to the card game group or league may select a lineup from the plurality of players, e.g., the player grid, such as described above. For example, a first friend may create a first lineup, a second friend may create a second lineup, and so on within the league. Multiple users, e.g., first friend, second friend, etc., may create lineups simultaneously without implied order or chronology. The plurality of players may update in real time based on the selections of the one or more friends. For example, player selections and changes to the player lineup may be displayed in the multiplayer room in real time where other users in the league may view the selections and changes. As another example, card selections may not be displayed until the gameplay period (or other real world event) start time. For example, each of the one or more friends may apply cards to the lineup, as described above. After the event has started, the card selections may be publicly displayed in the multiplayer room in real time. In one example, the card game UI overlay may show the lineup, the one or more cards selected for play, and the card effect value of the played card.

The event may progress in real time. At 316, the method may include cards taking effect when success metrics are met. As one example, an assigned card may have a potential to modify a player and overall points; however, the assigned card may not go into effect unless the player achieves a threshold success metric. In other words, the score effect value of an assigned card activates in response to achieving the threshold success metric. As a few examples, the threshold success metric may include a non-zero positive value threshold, such as a minimum number of points, passes, blocks, or other player statistic earned in the game. If the success metric is not met, the card may have no effect unless the card specifies a negative effect for not meeting the success metric.

At 318, the method may include the card game UI overlay notifying the users of the card effect via the event notification service. For example, in coordination with the event provider services 330 and the social platform provider services 328, the event notification service may display a live, social and activity feed that displays cards as the cards activate throughout the game and other events related to gameplay. When a player achieves the success metric for a card activation, the live feed may automatically update. The live feed may be viewable to each user in a league. In another example, users may react to the card activation in the social feed. For example, reactions may include icons, emojis, and comments that users may display in the live feed. In some examples, the reactions may be customized by the users, for example, using one or more modules of the user interest system 140 accessed via the social platform 102.

At 320, the method may include determining whether a card switch opportunity is indicated. In one example, a card switch opportunity may include a half time adjustment wherein users may exchange one or more played cards for an unplayed card (e.g., exchange an assigned card for an unassigned card). In one example, a card switch opportunity may be determined based on a second threshold airtime. For example, the user may exchange a card no later than the start of the third quarter of the event. In response to determining a card switch opportunity is not indicated, the method may include the event progressing in real time and cards taking effect when the success metrics are met. In another example, additionally, or alternatively, the exchange may be subject to a time threshold. In one example, the card switch opportunity may be determined by the card game system in coordination with one or both of the event API and the card API accessed via the event provider services 330 and the social platform provider services 328, respectively.

In response to determining a card switch opportunity is indicated, at 322, the method may include the card game UI overlay displaying a half time adjustment interface. In one example, the half time adjustment interface may display the deck of cards in possession of the user. Additionally, or alternatively, the half time adjustment interface displays an option to visit the card marketplace or the personalized store, as described above and with reference to FIG. 1A, where the user may purchase one or more cards to add to their deck of cards. One example method for purchasing cards in a card marketplace is described below with reference to the method 400 in FIG. 4.

The event progresses until the end, including cards taking effect when card success metrics are met. At 324, the method may include scoring and ranking the card game event based on event data and scoring algorithm settings. One example method for scoring a card game event is described below with reference to the method 500 in FIG. 5.

At 326, the method may include the card game UI overlay displaying the rank for the current card game event and historical data. The method may further include transmitting the rank, player statistics, and card game play data to one or more of the card database, the user database, and the scoring database that may be included in the social platform provider services 328.

In another example, a card game group or league may be created for an awards show according to one or more or all of the steps described with reference to the method 300. In such an example, the plurality of player may include persons nominated for one or more awards in the award show. The lineup may include each user's selection from a plurality of nominated persons to win each of the one or more awards. The cards may take effect when success metrics such as pre-show appearance on the red carpet, pre-show interviews, or on-camera time are met. The scoring and rank may be based on event data such as awards won and lost.

After 326, the method may return to the startup screen.

In this way, by creating personalized gaming content and social connection between social platform users in a simple, user-friendly interface, the disclosed method for a creating a card game group may increase engagement with a social platform. The method implements a distributed database architecture, with the first database dedicated to real time event data storage and management and the second database specialized for card storage, user selections, and score effect calculation. The dual database architecture reduces processing bottlenecks by separating real time event processing from the card effects. The approach allows for a large variety of event data to be shared with and utilized by the card game system.

Turning to FIG. 4, a flow chart depicting the method 400 for operating a card marketplace is shown. The method 400 may allow the user to view, purchase, and update a deck of cards while visiting the card marketplace. The method 400 may enable a user to build an individualized deck of cards, the individualized deck of cards comprising a user-collected subset of the plurality of cards, which may be played in a card game event. In some examples, the individualized deck of cards may be a user card library or a player card library.

The method 400 initiates in response to the social platform determining that a user has entered a marketplace. In one example, the marketplace may be similar to the card marketplace 178 described above with reference to FIG. 1A. In another example, the card marketplace may be similar to the personalized store associated with one of user accounts 122, 124, 126 that may be accessed via the user marketplace 130 as described with reference to FIG. 1A. In one example, the marketplace may be displayed within a card marketplace UI on the social platform, which may be displayed by a display (e.g., a display 184 in FIG. 1A). In one example, the card marketplace UI may be accessed via the card game UI described above with reference to the method 300 in FIG. 3. For example, the user may enter the card marketplace UI during a card switch opportunity, such as during half time of a card game event. As one example, the method may determine the user has entered the card marketplace in response to the user clicking an “enter” button in the card game UI. As one example, a user may purchase, view and update a deck cards while visiting the card marketplace.

At 401, the method includes the card marketplace UI displaying the deck of cards of the user. In some examples, the deck of cards may comprise the first deck of cards introduced above with reference to FIG. 3. In some examples, the deck of cards may comprise an individualized deck of cards including one or more cards that the user has purchased, upgraded (e.g., merged or traded, as discussed below), or otherwise earned or received.

At 402, the method includes the card marketplace UI displaying a plurality of cards currently available for purchase. An example card marketplace UI is described below with reference to FIG. 7. In one example, the card marketplace UI may display multipacks of cards, such as described above. For example, the cards included in the multipack may not be visible to the user until purchased by the user. The cards in the multipack may be random and have a set probability of common cards and premium or legendary cards. In another example, additionally, or alternatively, a random stock of cards may be presented in the card marketplace UI, where the cards and effects are displayed to the user. For example, the cards may be displayed including the type of card and/or rarity (e.g., common, premium, legendary, brand-affiliated), score effect (e.g., positive, negative, attack, function), score effect value (e.g., strength of the score effect), success metric (e.g., game points threshold), original price (e.g., price new), or other variables. In some examples, a cost of a card purchase may increase with strength of the score effect value and the rarity of the card. For example, a premium card may add more points to the fantasy score of the user when played, and also may cost more than a common card that adds fewer points to the fantasy score of the user when played. In one example, the card effect may be relevant to a single player to which it is applied at a time, a whole team, or have an attack value which works against an opposing user's team.

In one example, the plurality of cards currently available for purchase may include one or more customizable cards, which may have one or more customizable features that the user may adjust or control some aspect of. As a few examples, a customizable card available for purchase may include a card customization pack and a single card purchase option. For example, the card customization pack may include a set of cards having randomly generated functions or impacts. A single card from the pack may be selected for purchase individually. As another example, the card marketplace UI may display a league customization pack. For example, the method may include automatically generating a base or starter deck of cards that is playable in a given league by the league members.

At 404, the method may include receiving a card purchase. As one example, the method may receive the card purchase in response to the user clicking a button to confirm selection of one or more cards in the card marketplace UI. In one example, the user may purchase a card using virtual currency, in-game currency, social platform-based currency, social platform-based rewards, or real currency, such as described above with reference to FIG. 1A. For example, in response to receiving the card purchase, an amount of currency may be debited from the user account. In some examples, additionally, or alternatively, the card purchase may include a customizable card purchase. In such examples, the method at 404 may further include displaying one or more card customization tools, which the user may operate to customize (e.g., adjust, control) certain features of the customizable card. An example method for customizing cards is discussed below with reference to FIG. 9.

At 406, the method may include updating the deck of cards of the user based on the card purchase. For example, the one or more cards purchased in the card marketplace may be made available for use in a card game event immediately on purchase. As another example, the purchased card or cards may be played in a card game event according to the rules of the event and league. In one example, the deck of cards including the one or more purchased cards may be accessed, displayed, or both, on the social platform, such as via one or both of the card game UI overlay (e.g., see FIGS. 6A-7) and the user interests 128 of the user account 122 in FIG. 1A. The updated deck of cards may be stored as an individualized deck of cards on a database of the social platform.

At 408, the method may include determining whether a user store exit is indicated. As one example, the method may determine the user store exit in response to the user clicking an “exit” button displayed on the card marketplace UI. In response to determining the user store exit is not indicated, the method may return to 402, where the card marketplace UI displays currently available cards for view and purchase. In response to determining the user store exit is indicated at 408, the method may end.

In some examples, the method for a card marketplace may include an option to merge or trade in a user-selected set of common cards to upgrade to a premium or legendary card. As noted above, the method may include an option to create a personalized or customized card for a fee using in-game (virtual) currency, rewards, or real currency (e.g., as described with reference to FIG. 9 below). One example of a customized card may include special card creator rights for league creators (e.g., commissioners) or others, such as a right to create and apply cosmetic skins to cards used in the league. For example, cosmetic skins may include card imagery, coloring, or other ornamental features. In some examples, the method may include an option to cash in for rewards or virtual currency at the end of a league season one or more cards collected by a user. In other examples, the method may include an option to purchase a card subscription in the marketplace. In some examples, administrators of the card game system may select favorite user-generated cards for general sale in the card marketplace. In such examples, users who create a favorite card may receive some form of compensation such as special access to rare, limited edition, and preferred effects cards, or in-game currency for use in the card marketplace. In one example, the individualized deck of cards may be cleared at the end of the sport season. At the start of a new season or new sport, users may be provided a starter deck of cards and the opportunity to build the individualized deck starts over. However, in some examples, users may be able trade in some cards at the end of a sport season for a purchase credit toward the next year or sport seasons cards. In some examples some cards may carry forward to the next year's sport season.

Turning briefly to FIG. 9, a flow chart depicting the method 900 for card customization is shown. In some examples, the method 900 may be a sub-method of the method 400, enabling further personalization of the deck of cards of the user while visiting the card marketplace.

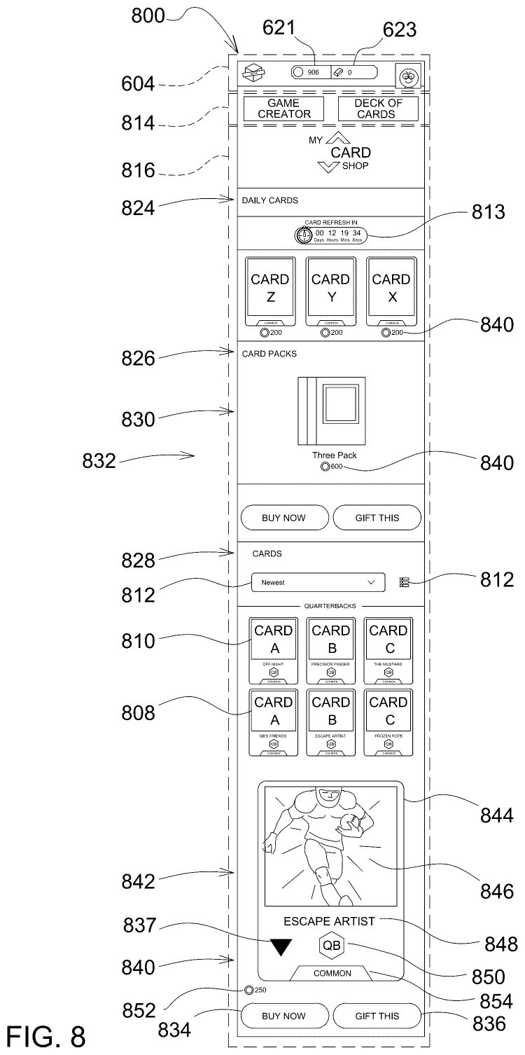

At 902, the method may include displaying card customization tools. In one example, card name and card imagery may be customized by a user. For example, the method may include displaying a UI where the user may enter a name and upload an image (e.g., a photo or other image file) from their device. As another example, the user may create original imagery using an AI image generator, such as the image generator 149 in FIG. 1A. Examples of card imagery are shown in FIGS. 7-8. Additionally, or alternatively, the customizable cards may have a customizable function. For example, the method may include presenting a plurality of pre-set card functions which the user may select from. As another example, a randomly generated function may be created for the custom card and the user may control the effect strength. For example, the method may include displaying a UI with a slider to allow the user to control the effect strength (e.g., risk or reward) associated with the effect of the custom card. In some examples, customizable cards may be editable by the user at a later time such as after initial customization.

At 904, the method may include receiving a customization selection. As one example, the method may receive the customization selection in response to the user clicking a button on the user interface to confirm selection of one or more of the customizable features of the customizable card. For example, the user may confirm selection of one or more of the custom image and name, card function, and effect strength.

At 906, the method may include generating a customized card based on the customization selection. Generating the customized card may include displaying a detailed view of the customized card on the user interface. The detailed view may include the customized features as well as non-customized or standard card features. An example detailed view is shown in FIG. 8 and may include, such as, for example, the card imagery, the card name, an associated player position, a purchase price, a trade value, and status (e.g., common, premium, or legendary).

At 908, the method may include saving the customized card and updating the deck of cards with the customized card. The saved card and updated deck of cards (e.g., individualized deck of cards) may be stored on a database of the social platform. For example, the one or more custom cards purchased and customized in the card marketplace UI may be made available for use in a card game event immediately on purchase. In one example, the customized cards may be accessed, displayed, or both, on the social platform, such as via one or both of the card game UI overlay (e.g., see FIGS. 6A-7) and the user interests 128 of the user account 122 in FIG. 1A.

At 910, the method may include determining whether a user store exit is indicated, such as described above with reference to FIG. 4. In response to determining the user store exit is indicated, the method may end.

In some examples, users may have different card customization levels. For example, individual users may purchase a single card, or a set of cards that they may customize for their own use or to gift to another player. For example, gifting may be done within the platform or sent via SMS. Further, the individual users may customize one or more of the look of the card, the name of the card, and the card effect. As noted above, individual card images may be customized using either the AI image generator, uploading an image, or the user may use the default image for the card. League creators may purchase a customizable starter deck for the created league. The league creator may customize each card of the starter deck in the same way that an individual user may customize a single card or set of cards. The customized starter deck then becomes the base deck for the created league. In some examples, each created league may have a corresponding custom starter deck, which may not be used across multiple leagues. However, other configurations of custom play are possible. In some examples, card decks may be specific to the sport. For example, there may be a basketball card database and a football card database, which comprises different cards than the basketball card database and vice versa.

In this way, by providing a user-friendly and personalized deck of cards building experience, and opportunities to build a card deck during game play and outside of game play, the disclosed method for operating a card marketplace may increase engagement with a social platform. As another advantage, by using multiple APIs between the event and social platform systems, the method may provide a large amount of data and UI information to the event system, while the event system provides the event specific data to the social platform. Such an arrangement may reduce memory and processing power demand of the social platform.

Turning to FIG. 5, a flow chart depicting the method 500 for scoring a card game event is shown. The method 500 may be one example of a scoring algorithm that may be used to assign rank in a card game group or league based on an outcome of one or more card game events. Each card played in the card game event may modify a fantasy score of the card game event in a different way. Further, the effect of the card on the card game event may depend on the performance of the players and the outcome of the event. The disclosed scoring algorithm manages the complexity of overlaying card effects on real time fantasy scoring.

At 502, the method may include collecting data at the end of a card game event. In one example, data may include raw scores, card effect values earned, and users involved. In one example, the raw scores may include points earned for play contributions in a game by a lineup of a user. In one example, the raw scores may be fantasy points calculated by a fantasy sports API. In another example, the raw scores may include awards earned and lost in an award show. In another example, the raw scores may include points assigned to various performance metrics in a contest. Continuing with the basketball example, the lineup may earn fantasy points for play contributions such as field goals, free throws, rebounds, assists, blocked shots, steals, and negative points for turnovers and fouls. In one example, a selected card is assigned to no more than one player in the lineup of the user. The card effect value of the selected card affects the player to which it is assigned and the player achieves the success metric. Continuing with the basketball example, positive card effect values may include extra points on field goals, free throws, rebounds, assists, blocked shots, and steals. Negative card effect values may include extra negative points for turnovers and fouls. In some examples, card effects vary based on a timeline, conditions of play, season, or other themes. In one example, the event data may be obtained in coordination with one or both of the event API and the card API, such as described above with reference to the method 300 in FIG. 3.

At 504, the method may include setting a base score based on the raw scores. For example, the method may include summing positive points and negative points earned during the event by each player in the lineup of the user to obtain the base score.

At 506, the method may include creating a balance sheet for each user. The balance sheet may include the base score and columns for applying advantage points and disadvantage points to the base score to calculate a final fantasy score. For example, advantage points may include boost cards that are applied to a scored performance of an individual player and attack cards that remove points from an individual player or from a team. Disadvantage points may include cards played against the lineup of the user, for example, played by an opponent in the card game group. In one example, cards may be additive or subtractive based on the card effect. In one example, cards may add or subtract points based on a single metric in the scored performance of a player. In one example, the card effect value may be a set point value or based on a percentage that is applied to the scored performance of a player, team, or base score.

At 508, the method may include applying advantage points for each effect earned by adding points directly to the user score or subtracting points from other users based on the earned effect.

At 510, the method may include applying disadvantage points for each effect earned by subtracting points from each affected user. In one example, subtracting points from each affected user may include subtracting points based on cards having a set negative impact. As another example, subtracting points from each affected user may include calculating the negative damage of the card and distributing the negative damage equally based on the number of players in the league. For example, if an attack card has a negative impact of 10 points, and there are 10 players in that league (not including the player that played the card), each player would receive-1 point score impact.

At 512, the method may include calculating final fantasy scores for display in the card game UI and use in card game play. In one example, the final fantasy score of each user may be based on a sum of the base score, the advantage points, and the disadvantage points. In one example, the card game UI may include a leaderboard. The leaderboard may display statistics and metrics that are tracked throughout the season and/or lifetime of the league. In one example, the leaderboard may update as the league plays more games. The leaderboard may comprise a live feed, which is viewable to users in the league. In one example, the leaderboard may include a variety of statistics and metrics by which to evaluate the performance of the league and league members (e.g., users). As a non-limiting example, the leaderboard may include statistics related to lineups, player performance, card usage, play frequency, and combinations thereof. As another example, leaderboard statistics may include total score (e.g., sum of final fantasy scores of league games played), total non-repeating cards played, total score from cards, or similar metrics, which may foster competition among frequent and veteran users. As another example, leaderboard statistics that involve ratios, such as win/loss ratio, average total score, average score from cards played, average attack card points, may foster competition among casual and frequent users, beginners and experienced players. The disclosed scoring algorithm efficiently integrates card game points earned with raw fantasy scores to calculate final fantasy scores, and further enables card game leagues to evaluate performance for variety of statistics and metrics. In this way, friendly competition may be fostered among users of varying experience, ability, and play frequency.

Turning now to FIG. 6A-C, FIG. 7, and FIG. 8, a plurality of frames of exemplary graphical user interfaces (GUI) 600, 700, and 800 are respectively shown. GUI 600, 700, and 800 may be displayed by a social platform to a user via a display of a user computing system as part of one or more methods herein disclosed. Generally, GUI 600, 700, and 800 comprise interfaces that may enable a user to engage with a personalized gaming environment on a social platform, such as the social platform 102. For example, users may view and interact with fantasy leagues and the personalized gaming environment using GUI 600, 700, and 800, thereby allowing users to evaluate and strategize potential and real time effects of deck building and card selection on a real time event. In particular, GUI 600 comprises an interface that may enable a user to create and participate in a card game group on a social platform. GUI 700 comprises an interface that may enable a user to modify card game play during a card game event. GUI 800 comprises an interface that may enable a user to view and purchase cards in a card marketplace. In one example, the personalized gaming environment illustrated by GUI 600, 700, and 800 may be created according to the systems and methods disclosed herein, such as the social platform system 100 in FIGS. 1A-B, and the method 300, the method 400, the method 500, and the method 900 in FIGS. 3-5, and 9, respectively. The example GUI 600, 700, and 800 illustrated herein may connect a variety of users, from sports fans, fantasy league veterans and beginners, and users with an affinity for games of chance and skill, with an immersive and dynamic gaming experience. FIGS. 6A-8 show example user interfaces for a card game experience based on professional football; however, it may be understood that a similar approach may be applied to other real time events such as, for example, professional and college basketball, college football, Olympic events, awards shows, reality television competitions, and so on.

Turning to FIGS. 6A, 6B, and 6C, GUI 600 shows an event play screen displaying a card game creator interface of a social platform. GUI 600 includes exemplary frames 602, 640, and 670, which are shown over FIGS. 6A-C and described collectively. Frame 602 displays UI elements 604 of the social platform, including an avatar 606 representing a first user, a plurality of buttons 608 configured for navigating between screens of the social platform, a wallet 611. The wallet 810 may include rewards 621 and virtual currency 623, which may be similar to the rewards and currency described above with reference to FIG. 1A. In one example, the user may be directed to the frame 602 upon navigating to a startup screen (not shown) displaying the card game creator 141 via the account of the user, such as account 122 on the social platform 102 in FIG. 1A. The startup screen may include various other inputs, such as a button configured to receive an indication from the user to start generating a card game group, another button configured to receive an indication to start a gaming experience without using a deck of cards, and another button configured to receive an indication from the user to join an existing card game group or to resume play with a card game group of which they are already a member. In some examples, such as examples where the user plays without a deck of cards or joins an existing game, the sequence of the exemplary frames 602, 640, and 670 may be different than described with reference to the GUI 600. In some examples, the startup screen may include a custom league cover that is customized by the user through use of a generative artificial intelligence system configured to create the custom league cover based on user input, as described with reference to the image generator 149 in FIG. 1A and the method 300 in FIG. 3.

Frame 602 displays a team selection interface including a budget 610 and a plurality of players, also referred to herein as a player grid or grid 612, and a button 622 (e.g., a “save button”). The grid 612 may be organized based on player position and rank. However, in other examples, the plurality of players may be organized and displayed differently. For example, the player position includes a first row 614 of quarterbacks (QB) and a second row 616 of running backs (RB), which are arranged by rank. In some examples, the grid 612 may further include player positions such as wide receiver (WR), tight end (TE), and defense/safety (DS) similarly arranged by rank. The rank includes a price for selecting a player for the lineup of the user. For example, the rank includes a first column 618 of player prices at $5, a second column 620 of player prices at $4, and so on from $3, $2, and $1. In one example, the user may add one player from each player position within the budget 610. In one example, the user may tap the player or otherwise indicate selection of the player. In the example, the budget 610 is $15. In other examples, other budgets may be assigned. For example, the user may add a player 615 for $5 to fill the QB player position on the lineup. The user may hit the button 622 to indicate that the user is done selecting the lineup.

A player tile may display statistics for each player on the grid 612. For example, player tile 624 may include a headshot 626, name 628, team 630 on which the player 615 plays, fantasy points 632 assigned to the player 615, home or away status 634, and opponent 636 to be played during the card game event. In some examples, to further help users know the best card to play on a given player, cards may include a symbol library to aid the process. For example, a running back card may have a lightning bolt symbol signifying that this card is best played on a running back known for their speed. That same symbol will also show up on the individual player tiles that are known for their speed. The symbols may help a user, not as familiar with specific player statistics, decide which card maybe more impactful for certain positions, as they can match the symbol on the card to the corresponding symbol on the player. For example, the player tile 624 may include a symbol 637 and some cards may have a corresponding symbol (e.g., corresponding symbol 837 in FIG. 8).

Frame 640 displays an example of a card selection interface where the user may choose one or more cards to play during a card game event. The frame 640 includes a lineup 642, card slots 644, a deck of cards 646 or user card library, and a tiebreaker 662. The lineup 642 may include the players selected via the frame 602. The user may apply up to one card to each of the card slots 644. For example, a first card 648 may be applied to a first card slot 650, a second card 649 to a second card slot 651, and so on until the slots are filled. In some examples, the user may drag and drop cards from the deck of cards 646 into the card slots 644. However, other UI actions are possible. The deck of cards 646 is an example of an individualized deck of cards that may include, for example, a plurality of one or more of user-collected cards, cards assigned in a starter deck, gifted cards, earned cards, and so on,

The frame 640 may include one or more UI elements 652 configured for navigating, e.g., scrolling, sorting, etc., through the deck of cards 646. As shown in the example, the UI elements 652 include one or more scroll bars and arrow icons. In the example, the deck of cards 646 is arranged by player position including a first position 654 (e.g., defense/safety) and a second position 656 (e.g., quarterback). The user may scroll through the first position 654 and the second position 656 by operating the UI elements 652. Two positions are shown by way of example, however the card selection interface may include fewer or more positions, such as, corresponding to the positions in the fantasy sport. Additionally, or alternatively, the card selection interface may include other categories of cards. Additionally, or alternatively, other UI elements are possible including, but not limited to, a drop down menu with sorting features such as newest to oldest held by the user, card effect value, playability, and so on. In one example, some cards may be held by the user but not playable in a card game event. For example, some cards may not be used in back to back card game events, e.g., subject to a “cool down” period. As another example, some cards may not be playable two days in a row. In one example, each card may include graphics and details that make the card easily recognizable by users and provide information about the effect of playing the card in a card game event. In some examples, the card may include a front and a back. In some examples, the cards may include a border design that indicates whether the card is common, premium, brand-sponsored, and other features. In one example, the first card 648 may include representative imagery, a card title, and a brief description of the card effect value. An example of a card is shown in FIG. 7.

The frame 640 may include a first button 658 configured to receive the user input to save the selection of cards and a second button 660 configured to receive the user input to generate an automatic selection of cards. The frame 640 may further include a tiebreaker 662 with a text box 664 and a third button 666. In some examples, the tiebreaker 662 appears in response to the user confirming the card selection, such as in response to the user selecting the first button 658. In one example, the tiebreaker 662 comprises a game wherein one or more users guess the sum of the score of one or more games associated with the fantasy league. For example, the user inputs a guess into the text box 664 and submits the guess by hitting the third button 666. In one example, the winner is the user who guesses closest to the combined score without going over. In another examples, if users guess over the actual combined score, the winner is the user who guesses closest to the combined score.

Frame 670 displays an example of a multiplayer card game interface. The frame 670 includes a league cover 672 with custom cover art 674, league name 676, and user ID 678 of the card game creator (e.g., league commissioner). The frame 670 includes a timer 680, which may indicate a live event or may display a countdown to an upcoming event, and a season bar 681 showing the time in the game season. Frame 670 displays a first status 682 associated with the card game creator and one or more of a second status 684 associated with each additional user in the card game group, such as a second user or friend who accepted an invitation to the card game group by the user. For example, the first status includes the avatar 606 and associated first user ID, the lineup 642, the card slots 644 and selected cards of the card game creator. The second status includes a second avatar 686 and associated second user ID, a second lineup 688 and second slots 690 including cards selected by the friend.

The status of each player in the card game group, e.g., the first status 682 and the second status 684, may include a variety of statistics related to the league. For example, total scores 695 based on the fantasy score of the lineup and the cards played, overall fantasy points 696 of the lineup (e.g., without cards factored in), individual points 697, card-related points 698, earned card-related points 675, attack points 699, and so on, may be displayed on the frame 670. In one example, the card-related points 698 may display the potential scoring effect of the card. The earned card-related points 675 may display the sum of earned effects of activated cards of the user, e.g., where the threshold success metric is met. The attack points 699 may display the sum of score effects of earned by other users.

The frame 670 may further include a social button 692 and a card marketplace button 694. In one example, in response to the user selecting the social button 692 the GUI 600 may display a menu of other users of the social platform who are affiliated with the user. The user may invite other users to the card game group via the social button. In another example, additionally, or alternatively, in response to the user selecting social button 692, the GUI 600 may display an interface where the user may invite friends who are not affiliated with the social platform. In one example, in response to the user selecting the card marketplace button 694, the GUI 600 may display a virtual environment where the user can view can browse and purchase cards available for card deck building. An example of a card marketplace GUI is described in more detail with reference to FIG. 8 below.

In one example, users may create a fantasy league experience without the card game overlay via the GUI 600. In such an example, the GUI 600 may provide an easily navigable interface for fantasy league creation, team selection, fantasy league play, scoring, and other social interaction.

Turning to FIG. 7, GUI 700 shows an example of a halftime adjustment interface that is configured to enable a user to modify card game play during a card game event. In one example, the user may be directed to the halftime adjustment interface in response to the user indicating a desire to switch cards during the card game event. The GUI 700 may display one of more of the UI elements 604 of the social platform introduced above with reference to the GUI 600 in FIGS. 6A-6C, such as the avatar 606 and the wallet 611 including rewards 621 and virtual currency 623. The GUI 700 further displays the lineup 642, card slots 644, the first button 658, and the deck of cards 646. In one example, the user may select one or more cards for exchange in the halftime adjustment interface. In the example, the user selects a played card 715 for exchange. The user may hit the first button 658 to exchange the played card 715 with a card selected from the deck of cards 646.

GUI 700 displays the deck of cards 646 and the user may select one or more cards from the deck of cards 646 to exchange with one or more played cards during the card game event. As above, the deck of cards 646 is arranged by player position, including the first position 654 and the second position 656, and the user may operate the UI elements 652 to navigate through the deck of cards 646 and select one or more cards to swap out for one or more played cards. In some examples, during halftime adjustment, the user may exchange a set number of cards. For example, the user may exchange no more than one card, e.g., the played card 715.

GUI 700 displays a detail interface 702 of an example of a card 704 including a select card button 706, an upgrade to premium button 708, and a close button 722. The card 704 is a common card. In some examples, the user may click the select card button 706 to exchange the played card 715 for the card 704. In some examples, users may have the ability to combine a plurality of common cards (e.g., three) to upgrade to a single premium card, giving it more influence than a common card. For example, the user may select three cards from the deck of cards 646 and the user may click the upgrade to premium button 708 to indicate the choice to exchange for the selected cards for the single premium card. The premium card may provide a higher level function or an increased effect. The close button 722 may be clicked to exit the detail view of a selected card.

In some examples, the user may confirm the one or more card exchanges and exit the halftime adjustment. In response, the multiplayer card game interface may be displayed, such as described above with reference to the GUI 600 in FIG. 6C. For example, the multiplayer card game interface may display the selections of other users in the card game group, such as selections made by other users during the halftime adjustment.

Turning to FIG. 8, GUI 800 shows an example of a card game interface that is configured to enable a user to engage with a card game system. In one example, the user may access the card game interface with an account affiliated with a social platform, such as user account 122 affiliated with the social platform 102 as described above with reference to FIG. 1A. For example, the card game interface may be selectable among user interests 128 associated with the account 122. Elements of the GUI 800 that were introduced above with reference to GUI 600 and the GUI 700 in FIGS. 6A-7 are numbered the same and not reintroduced.

The GUI 800 includes a timer 813, one or more links 814, and a card marketplace 816. In some examples, a timer, such as the timer 813 may count down to one or more events related to the social platform, the card marketplace, or card game events, such as the start time of a scheduled professional basketball game, other sports event, or other scored event, such as described in the example methods of FIGS. 3-5, and 9 and the systems and diagrams 100, 200, 250 of FIGS. 1A-2B. The one or more of links 814 may correspond to other areas of the social platform, such as, for example, the card game creator interface, the multiplayer interface, the deck of cards associated with the user, brand-sponsored virtual environments including advertisements, entertainment content, and other virtual environments of the social platform. In one example, the user may select a link of the one or more of links 814 links to navigate to a respective interface of the card game system.

The card marketplace 816 includes a daily store 824, a card pack 826, and a card catalog 828. The daily store 824 may be one example of a personalized store that may be generated for a platform user including a randomly generated set of cards available for purchase that are reset at a regular interval. As shown in the example, the timer 813 counts down an interval of time until the randomly generated set of cards available for purchase in daily store resets. The card pack 826 may be one example of a multipack of cards that the user may purchase as a set without foreknowledge of the card effects. In one example, the card catalog 828 may include a menu of cards in current circulation on the card game system, including, for example, a plurality of common cards, a plurality of premium cards, and a plurality of legendary cards. In one example, the user may select one or both of cards from the daily store 824 and the card pack 826 for purchase.

The daily store 824 includes one or more selected daily cards 838 and one or more corresponding purchase prices 840. The card pack 826 includes a randomly generated set of cards 830 and a corresponding price 832. Buttons 834, 836 may be displayed that are configured to enable the user to buy or gift one or more of the daily cards 838 and randomly generated set of cards 830. In some examples, cards in one or both of the daily store 824 and the card pack 826 may include customizable cards, which are configured to enable users to customize features of the cards such as, but not limited to, the card imagery and strength of effect.

The card catalog 828 may display a plurality of cards 808, 810, and UI elements 812 that may be operated by the user to search the card catalog 828. The card catalog 828 may display a detailed view 842 of a selected card 844. The detailed view 842 may show one or more or all of a card imagery 846, a card name 848, an associated player position 850, a purchase price 852, and status 854 (e.g., common, premium, legendary). The selected card may include a symbol, such as corresponding symbol 837, which corresponds to the symbol that is presented on a player tile, such as symbol 637 in FIG. 6A. As noted above, the symbols and corresponding symbols may assist users by illustrating which card effects may result in the greatest advantage when played. The detailed view 842 may further include features not shown in the example, such as the effect value of the card, the scoring or event threshold for the card to go into effect in a card game event, or other playability details such as the associated “cooldown period” or frequency that the card can played in card game events or leagues. In some examples, the card catalog 828 may include one or more customized cards that are created by other users, league commissioners, brands, other users.

The example graphical user interfaces provided in FIGS. 6A-8 create a personalized gaming environment where users may create card game groups, engage with card game groups, and build and customize individualized decks of cards.

In this way, a social platform may encourage loyalty among a broad range of users. The disclosed systems and methods may provide opportunities for repeated play and continuous engagement, offer a variety of outcomes based on player choices, including elements of skill, which may appeal to a wide range of users, from sports fans and fantasy league veterans to beginners and experienced gamers. The examples of original game content disclosed herein may enhance fantasy league play with a strategic, social, and customizable layer including merging card effects on top of existing fantasy scoring. By encouraging customization, and incentivizing interaction with the social platform via user-generated content, platform-based communities, user rewards, and personalized marketplaces, and reducing barriers to entry with an easy to understand and rich user interface, the disclosed systems and methods may maximize user engagement.

The systems and methods disclosed herein integrate real time sporting events with a card-based fantasy gaming system. The platform allows users to select players for a fantasy lineup and modify performance of the fantasy lineup through collectible digital cards that can be acquired through gameplay, purchases, customization, gifting, and entering challenges, contests or competitions on the platform. The technical implementation includes a distributed database architecture that separates real time event processing from card effect calculations, optimized scoring algorithms, and efficient memory management. The platform includes a marketplace for card trading and customization, social features for league creation and management, and a scoring system that integrates both real time event data and card effects. The user interface provides intuitive card management, player selection within budget constraints, and real time score tracking. The technical solution addresses the challenge of engaging users in fantasy sports by adding a strategic layer of card effects while maintaining system performance and data consistency through its specialized architecture and processing optimizations. The technical architecture of the system described herein represents an improvement over conventional platforms by solving specific technical challenges related to real time data integration, concurrent user access, and efficient processing of complex card effects while maintaining data consistency and system performance.

In some embodiments, the disclosed systems and methods may include special card effects. One example of special card effects may include user-specific attack cards. Another example may include custom league cards that are created by commission and given to each league participant. Another example may include card chaining wherein some cards have the ability to work with other cards for altered effects. Another example may include a weekly set of cards that include predictions for play that week. Such cards may be used to replace one of the cards currently assigned to the lineup of a user during game play. Another example may include cards designed to be played at a particular time of gameplay and not used outside of the particular time. Another example may include limited use cards which may be played for no more than a threshold number of games, time, leagues, etc. Another example may include an option or opportunity to add an additional card slot, e.g., a 6th card. In another example, the card game system may include day-specific card purchases, e.g., Monday night madness. In another example, the card game system may include card subscriptions. Some examples may include card gifting. Some examples may include post season game play. Some examples may include cards that may be “tried out” before purchasing. Some examples may include a league draft day that gives players access to purchase from the full library of cards. For example, the league draft day may be held at regular intervals such as once per year. Another example may include parlay play wherein a user may pick the over/under on a group of players on their lineup for extra points, such as a group of three players. Another example may include wagering fantasy points on in-game events. Another example may include opportunities for card earning. For example, some cards may be earned by a commissioner. Some cards may be earned in response to winning a competition. Some cards may be traded in for others. For example, if a user has multiples of the same card, the user may trade in one or more of the same cards for in-game currency, rewards, other cards, etc.

The disclosure also provides support for a method for a social platform, comprising: receiving from a first database a real time event and a plurality of players participating in the real time event, receiving a player selection from the plurality of players and storing the player selection in a second database, the player selection comprising a subset of players that is fewer in number than the number of players in the plurality of players, receiving from the second database a plurality of cards, the plurality of cards configured for collection by one or more users, and comprising an effect that modifies a fantasy score of the real time event, defining a first set of the plurality of cards to form a first deck of cards, accessing through a marketplace a second set of the plurality of cards and storing the second set and the first set of the plurality of cards as an individualized deck of cards in the second database, receiving a card selection from the individualized deck of cards, the card selection assigned to a player of the player selection, creating a score effect on the player, and determining the fantasy score integrating the real time event and the score effect. In a first example of the method, the first deck of cards comprises an assigned subset of the plurality of cards, and wherein the individualized deck of cards comprises a user-collected subset of the plurality of cards. In a second example of the method, optionally including the first example, the plurality of cards comprises a score effect value and a rarity. In a third example of the method, optionally including one or both of the first and second examples, a cost to purchase a card in the marketplace increases with strength of the score effect value and the rarity. In a fourth example of the method, optionally including one or more or each of the first through third examples, the plurality of cards comprises one or more customizable cards. In a fifth example of the method, optionally including one or more or each of the first through fourth examples, the card selection assigned comprises a threshold success metric, and wherein the score effect activates in response to achieving the threshold success metric. In a sixth example of the method, optionally including one or more or each of the first through fifth examples, the method further comprises: a card switch opportunity, the card switch opportunity comprising exchanging an assigned card for an unassigned card from the individualized deck of cards, wherein the card switch opportunity is presented during the real time event. In a seventh example of the method, optionally including one or more or each of the first through sixth examples, the real time event comprises a numerically scored, or potentially numerically scored, sporting or competitive event. In a eighth example of the method, optionally including one or more or each of the first through seventh examples, the fantasy score comprises fantasy points earned during the real time event and the effect of the cards assigned on the fantasy points, and wherein the effect of each card comprises one of an advantage effect that increase the fantasy score of the real time event and a disadvantage effect that reduces the fantasy score of the real time event. In a ninth example of the method, optionally including one or more or each of the first through eighth examples, determining the fantasy score comprises: collecting data at the end of the real time event, the data comprising raw scores, card effects earned, and users, setting a base score based on the raw scores, creating a balance sheet for each user of the users, applying advantage points for each effect earned by one of adding points directly to the base score of each user or subtracting points from the base score of other users, applying disadvantage points for each effect earned by subtracting point from the base score of each affected user, and calculating a final fantasy score for each user based on a sum of the base score, the advantage points, and the disadvantage points.

The disclosure also provides support for a card game system comprising: a card game event comprising a real time event and a plurality of players participating in the real time event, a database storing a plurality of cards configured to modify a fantasy score of the real time event based on player performance in the real time event and a score effect of the plurality of cards, a first set of the plurality of cards defined as a first deck of cards, a marketplace in electronic communication with the database, and a non-transitory machine-readable storage medium having instructions that when executed by a processor, causes the processor to perform operations comprising: automatically retrieve a second set of cards of the plurality of cards, display the second set of cards in the marketplace, receive a card purchase from the second set of cards, update the first deck of cards based on the card purchase, automatically store in the database the updated first deck of cards as an individualized deck of cards, and, retrieve the individualized deck of cards for the card game event. In a first example of the system, the plurality of cards comprises a score effect value and a rarity, and wherein a cost of the card purchase in the marketplace increases with a strength of the score effect value and the rarity. In a second example of the system, optionally including the first example, the plurality of cards comprises a plurality of legendary cards, a plurality of premium cards and a plurality of common cards, and wherein a premium card adds more points to the fantasy score and is rarer than a common card that adds fewer points to the fantasy score, and wherein a legendary card adds more points to the fantasy score and is rarer than the premium card. In a third example of the system, optionally including one or both of the first and second examples, the instructions further comprising: receive a user-selected set of common cards, and exchange the user-selected set for a single premium card. In a fourth example of the system, optionally including one or more or each of the first through third examples, the card purchase comprises a customizable card, and wherein the instructions further comprising: display card customization tools, receive a customization selection, generate a customized card based on the customization selection, save the customized card and update the individualized deck of cards with the customized card.

The disclosure also provides support for a non-transitory machine-readable storage medium including instructions that, when executed by a machine, cause the machine to perform operations comprising: providing a user interface by a social platform to create a card game group, receiving from a first database a real time event and a plurality of players participating in the real time event and displaying the plurality of players on the user interface, receiving from a first user a player selection from the plurality of players and storing the player selection as a first lineup in a second database, receiving from the second database a plurality of cards, the plurality of cards configured for collection by one or more users, and each card comprising an effect that modifies a fantasy score of the real time event, defining a first set of the plurality of cards to form a first deck of cards of the first user and displaying the first deck of cards on the user interface, retrieving the first deck of cards for the real time event, receiving a card selection from the first deck of cards, the card selection assigned to a player of the first lineup and creating a score effect on the player, displaying the first lineup and the card selection on the user interface, and automatically generating an invitation for a second user to join the card game group. In a first example of the system, one or more cards of the plurality of cards are configured for purchase in a marketplace on the user interface using one or more of virtual currency, in-game currency, rewards, and real currency. In a second example of the system, optionally including the first example, one or more of the virtual currency, in-game currency and rewards is earned through participation in activities hosted via the social platform. In a third example of the system, optionally including one or both of the first and second examples, the plurality of players comprises an automatically generated group of top ranked players, and wherein the player selection comprises one player from each player position participating in the real time event without exceeding a budget. In a fourth example of the system, optionally including one or more or each of the first through third examples, the system further comprises: displaying a leaderboard via the social platform, the leaderboard comprising statistics and metrics associated with the card game group.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for a social platform, comprising:
receiving from a first database a real time event and a plurality of players participating in the real time event;
receiving a player selection from the plurality of players and storing the player selection in a second database, the player selection comprising a subset of players that is fewer in number than the number of players in the plurality of players;
receiving from the second database a plurality of cards, the plurality of cards configured for collection by one or more users, and comprising an effect that modifies a fantasy score of the real time event;
defining a first set of the plurality of cards to form a first deck of cards;
accessing through a marketplace a second set of the plurality of cards and storing the second set and the first set of the plurality of cards as an individualized deck of cards in the second database;
receiving a card selection from the individualized deck of cards, the card selection assigned to a player of the player selection;
creating a score effect on the player; and
determining the fantasy score integrating the real time event and the score effect.

2. The method of claim 1, wherein the first deck of cards comprises an assigned subset of the plurality of cards, and wherein the individualized deck of cards comprises a user-collected subset of the plurality of cards.

3. The method of claim 1, wherein the plurality of cards comprises a score effect value and a rarity.

4. The method of claim 3, wherein a cost to purchase a card in the marketplace increases with strength of the score effect value and the rarity.

5. The method of claim 1, wherein the plurality of cards comprises one or more customizable cards.

6. The method of claim 1, wherein the card selection assigned comprises a threshold success metric, and wherein the score effect activates in response to achieving the threshold success metric.

7. The method of claim 1, further comprising a card switch opportunity, the card switch opportunity comprising exchanging an assigned card for an unassigned card from the individualized deck of cards, wherein the card switch opportunity is presented during the real time event.

8. The method of claim 1, wherein the real time event comprises a numerically scored, or potentially numerically scored, sporting or competitive event.

9. The method of claim 1, wherein the fantasy score comprises fantasy points earned during the real time event and the effect of the cards assigned on the fantasy points, and wherein the effect of each card comprises one of an advantage effect that increase the fantasy score of the real time event and a disadvantage effect that reduces the fantasy score of the real time event.

10. The method of claim 1, wherein determining the fantasy score comprises:
collecting data at the end of the real time event, the data comprising raw scores, card effects earned, and users;
setting a base score based on the raw scores;
creating a balance sheet for each user of the users;
applying advantage points for each effect earned by one of adding points directly to the base score of each user or subtracting points from the base score of other users;
applying disadvantage points for each effect earned by subtracting point from the base score of each affected user; and
calculating a final fantasy score for each user based on a sum of the base score, the advantage points, and the disadvantage points.

11. A card game system comprising:
a card game event comprising a real time event and a plurality of players participating in the real time event;
a database storing a plurality of cards configured to modify a fantasy score of the real time event based on player performance in the real time event and a score effect of the plurality of cards;
a first set of the plurality of cards defined as a first deck of cards;
a marketplace in electronic communication with the database; and
a non-transitory machine-readable storage medium having instructions that when executed by a processor, causes the processor to perform operations comprising:
automatically retrieve a second set of cards of the plurality of cards;
display the second set of cards in the marketplace;
receive a card purchase from the second set of cards;
update the first deck of cards based on the card purchase;
automatically store in the database the updated first deck of cards as an individualized deck of cards; and,
retrieve the individualized deck of cards for the card game event.

12. The card game system of claim 11, wherein the plurality of cards comprises a score effect value and a rarity, and wherein a cost of the card purchase in the marketplace increases with a strength of the score effect value and the rarity.

13. The card game system of claim 11, wherein the plurality of cards comprises a plurality of legendary cards, a plurality of premium cards and a plurality of common cards, and wherein a premium card adds more points to the fantasy score and is rarer than a common card that adds fewer points to the fantasy score, and wherein a legendary card adds more points to the fantasy score and is rarer than the premium card.

14. The card game system of claim 13, wherein the instructions further comprising:
receive a user-selected set of common cards; and
exchange the user-selected set for a single premium card.

15. The card game system of claim 11, wherein the card purchase comprises a customizable card, and wherein the instructions further comprising:
display card customization tools;
receive a customization selection;
generate a customized card based on the customization selection;
save the customized card and update the individualized deck of cards with the customized card.

16. A non-transitory machine-readable storage medium including instructions that, when executed by a machine, cause the machine to perform operations comprising:
providing a user interface by a social platform to create a card game group;
receiving from a first database a real time event and a plurality of players participating in the real time event and displaying the plurality of players on the user interface;
receiving from a first user a player selection from the plurality of players and storing the player selection as a first lineup in a second database;
receiving from the second database a plurality of cards, the plurality of cards configured for collection by one or more users, and each card comprising an effect that modifies a fantasy score of the real time event;
defining a first set of the plurality of cards to form a first deck of cards of the first user and displaying the first deck of cards on the user interface;
retrieving the first deck of cards for the real time event;
receiving a card selection from the first deck of cards, the card selection assigned to a player of the first lineup and creating a score effect on the player;
displaying the first lineup and the card selection on the user interface; and
automatically generating an invitation for a second user to join the card game group.

17. The non-transitory machine-readable storage medium of claim 16, wherein one or more cards of the plurality of cards are configured for purchase in a marketplace on the user interface using one or more of virtual currency, in-game currency, rewards, and real currency.

18. The non-transitory machine-readable storage medium of claim 17, wherein one or more of the virtual currency, in-game currency and rewards is earned through participation in activities hosted via the social platform.

19. The non-transitory machine-readable storage medium of claim 17, wherein the plurality of players comprises an automatically generated group of top ranked players, and wherein the player selection comprises one player from each player position participating in the real time event without exceeding a budget.

20. The non-transitory machine-readable storage medium of claim 17, further comprising displaying a leaderboard via the social platform, the leaderboard comprising statistics and metrics associated with the card game group.
